(19) United States
(12) Patent Application Publication
(10) Pub. No.: US 2026/0162084 A1
(43) Pub. Date: Jun. 11, 2026

(54) DIGITAL PLATFORM FOR EPHEMERAL CRYPTOCURRENCY ADDRESSES FOR DIGITAL WALLETS AND AUTHORIZED CRYPTOCURRENCY KEY EXCHANGES

(71) Applicant: PAYPAL, INC., San Jose, CA (US)

(72) Inventors: Paul Unterberg, San Jose, CA (US); Vipin Dwivedi, San Jose, CA (US); Mukesh Gopinadhan, Marietta, GA (US); Ian Barile, Palo Alto, CA (US); Paul Bances, Doral, FL (US); Kunalkumar Somani, Fremont, CA (US)

(21) Appl. No.: 18/970,766

(22) Filed: Dec. 5, 2024

(51) Int. Cl. G06Q 20/06; G06Q 20/38; G06Q 20/40

(52) U.S. Cl. CPC G06Q 20/06; G06Q 20/3829; G06Q 20/405

(57) ABSTRACT

Methods and systems described herein may implement blockchain cryptocurrency transactions in a variety of environments. An online transaction processor may provide operations for ephemeral cryptocurrency wallets and platforms. The transaction processor may receive a request for an entity to establish an ephemeral digital wallet, which may correspond to a digital wallet that does not remain permanently open and usable for cryptocurrency transactions in contrast to conventional digital wallet address that are always active once a blockchain and its addresses have been established. The transaction processor may utilize a digital platform with a governor software function that may limit the usage of the wallet address on the blockchain to approved cryptocurrency key transfers and transactions. A whitelist may be established with the governor function that may designate allowable addresses that may deposit cryptocurrency through key transfers, as well as addresses or conditions for cryptocurrency payments or withdrawals.

### TECHNICAL FIELD

The present disclosure generally relates to blockchain technology and hardware and software related thereto. More specifically, the present disclosure relates to systems and methods for implementing digital cryptocurrency wallets in a variety of environments, including ephemeral address and wallet platforms for limited cryptocurrency transfers.

### BACKGROUND

Users may utilize online electronic transaction processors to process transactions between end users as well as exchange and transfer funds. This may include transactions at physical merchant locations with real-world merchants, as well as online transactions on digital merchant marketplaces and the like. Users may have available cryptocurrency, which may be stored by and transferred to and from a digital wallet. Further entities, such as online transaction processors, cryptocurrency trading platforms, merchants, and the like may also use digital wallets to manage cryptocurrency. To facilitate these exchanges and transfers of cryptocurrency, digital wallet addresses may be used, which may exist on a blockchain and allow for monitoring cryptocurrency exchanges. However, cryptocurrency, once transferred, is difficult to claw back due to the permanence of a cryptocurrency transaction (e.g., the transaction cannot be modified or deleted on a blockchain) and the anonymity of digital wallet holders. As such, users and entities must be confident in their transfers because incoming transactions of cryptocurrency from unknown senders may be difficult to reverse and send back. Further, entities may receive cryptocurrency in a digital wallet that is no longer able to be used and/or monitored, causing users and entities to encounter loss. As such, there exists a need for entities to provide an ephemeral digital wallet that can be opened and closed for specific purposes and periods of times, and where controls of incoming and outgoing cryptocurrency can be strictly controlled. Thus, it is desirable to provide users and entities with faster, more efficient, and more secure cryptocurrency transaction processing through ephemeral digital wallets.

### BRIEF DESCRIPTION OF THE DRAWINGS

The accompanying drawings, which are included to provide further understanding and are incorporated in and constitute a part of this specification, illustrate disclosed embodiments and, together with the description, serve to explain the principles of the disclosed embodiments. In the drawings:

FIG. 1 illustrates an environment of an exemplary computing architecture for facilitating one or more blockchain based transactions, according to an embodiment;

FIG. 2 illustrates an environment of an exemplary blockchain network, according to an embodiment;

FIG. 3 illustrates a block diagram of an exemplary blockchain, according to an embodiment;

FIG. 4 illustrates a block diagram of an exemplary transaction message, according to an embodiment;

FIG. 5 illustrates a block diagram of an exemplary transaction broadcast the blockchain network, according to an embodiment;

FIG. 6A illustrates a flow diagram showing steps of an example method for performing a blockchain based transaction, according to an embodiment;

FIG. 6B illustrates a flow diagram showing steps of an example method for performing a blockchain based transaction, according to an embodiment;

FIG. 7A illustrates an example of a privately broadcasted blockchain, according to an embodiment

FIG. 7B illustrates an example of blockchain misuse, according to an embodiment;

FIG. 8 illustrates a block diagram of a blockchain enabled in-store purchase system, according to an embodiment;

FIG. 9 illustrates a block diagram of a blockchain enabled in-vehicle purchase system, according to an embodiment;

FIG. 10 illustrates a block diagram of a networked system suitable for implementing the processes described herein, according to an embodiment;

FIG. 11 illustrates an exemplary diagram of an ephemeral digital wallet interacting with other digital wallets for cryptocurrency transactions that may be managed by a digital platform enforcing a whitelist for authorized cryptocurrency key exchanges through a governor function, according to an embodiment;

FIG. 12 illustrates an exemplary system environment where a digital platform may provide ephemeral digital wallet service for cryptocurrency transactions with a digital wallet address, according to an embodiment;

FIG. 13 illustrates a flowchart for a digital platform for ephemeral cryptocurrency addresses for digital wallets and authorized cryptocurrency key exchanges, according to an embodiment; and

FIG. 14 illustrates a block diagram of a computer system suitable for implementing one or more components in FIG. 1, according to an embodiment.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized, and structural and functional modifications may be made, without departing from the scope described herein. Various aspects are capable of other embodiments and of being practiced or being carried out in various different ways.

In its broadest sense, blockchain refers to a framework that supports a trusted ledger that is stored, maintained, and updated in a distributed manner in a peer-to-peer network. For example, in a cryptocurrency application, such as applications for Bitcoin or Ethereum, Ripple, Dash, Litecoin, Dogecoin, zCash, Tether, Bitcoin Cash, Cardano, Stellar, Monero, and the like, or in digital currency exchanges, such as Coinbase™, Kraken™, and others, the distributed ledger represents each transaction where units of the cryptocurrency are transferred between entities. For example, using a digital currency exchange, a user may buy any value of digital currency or exchange any holdings in digital currencies into worldwide currency or other digital currencies. Each transaction can be verified by the distributed ledger, and only verified transactions are added to the ledger. The ledger, along with many aspects of blockchain, may be referred to as “decentralized” in that a central authority is typically not present. Because of this, the accuracy and integrity of the ledger cannot be attacked at a single, central location. Modifying the ledger at all, or a majority of, locations where it is stored is made difficult so as to protect the integrity of the ledger. This is due in large part because individuals associated with the nodes that make up the peer-to-peer network have a vested interest in the accuracy of the ledger.

Though maintaining cryptocurrency transactions in the distributed ledger may be the most recognizable use of blockchain technology today, the ledger may be used in a variety of different fields. Indeed, blockchain technology is applicable to any application where data of any type may be accessed where the accuracy of the data is assured. In some embodiments described herein, blockchains and cryptocurrency may be utilized to provide digital transfers of value or assets through digital wallets, where a service provider may implement a digital platform to provide ephemeral wallet addresses that may control cryptocurrency key exchanges. Conventionally, cryptocurrency digital wallets are permanent and not closeable or capable of being deleted and removed from a blockchain. This is due to the nature of cryptocurrency and corresponding digital addresses on a blockchain, where, once a blockchain is established, all addresses that can exist, do and will continue to exist for that blockchain. As such, when a digital wallet having a wallet address on the blockchain ceases to provide its intended purposes or use, the address still exists on the blockchain, leading to potentially inappropriate and/or mistaken cryptocurrency transactions and loss of cryptocurrency and its value. Further, cryptocurrency and digital wallets and notoriously prone to theft, fraud, and misappropriation, where controls on outgoing cryptocurrency transactions are difficult to enforce, and lost cryptocurrency from fraudulent transactions cannot be clawed back.

Instead, according to various embodiments, a service provider may utilize a digital platform to control digital wallet lifecycle and use, which may be used to provide an ephemeral digital wallet and wallet address for limited use. This may be done using a governor function at the digital platform to monitor incoming and outgoing key exchanges for the digital wallet and to/from the wallet's digital address. The governor function may implement a whitelist and/or other authorization control on the digital wallet to only allow cryptocurrency deposits and/or withdrawals to certain other wallet addresses and/or based on authorization conditions (e.g., a valid identification, a known or authorized wallet address or username, an authorization code, an administrator authorization or approval, etc.), as well as for a limited length of time. As such, the governor function may control incoming and outgoing cryptocurrency transactions, thereby providing ephemeral digital wallets and addresses through controlled usage. Entities may therefore control who (either users or other entities) may deposit or transfer cryptocurrency into the digital wallet, such as by limiting those wallet addresses and/or identifications that may be identified as senders of cryptocurrency to the digital wallet, as well as who may request and/or receive cryptocurrency from the digital wallet (e.g., payees or recipient addresses/identifications).

In this regard, online transaction processors, such as PayPal® or Venmo®, may be used to process transactions electronically using cryptocurrency, virtual currency, and the like, which may provide users with the functionality to convert or sell cryptocurrency available to or held by the user in order to process a transaction. In order to provide cryptocurrency usage to users and entities, the transaction processor may utilize a digital wallet having cryptocurrency in different amounts, values, and/or currencies, which may allow for cryptocurrency transactions with different entities through their wallet addresses (e.g., which may act as the sender/receiver point for cryptocurrency transactions). The transaction processor may receive a request for processing a transaction and/or making a transfer from one wallet address to another using cryptocurrency available to the digital wallet(s). The transaction processor may process a transaction using the available cryptocurrency from the entity's and/or user's digital wallet, which may be required to comply with the conditions, rules, and/or authorizations of the digital platform and governor function controlling the digital wallet.

For electronic transaction processing and digital payments made using cryptocurrency balances and cryptocurrency processing services, an online service provider (e.g., an online transaction processor, such as PAYPAL®) may provide account services to users and entities of the online service provider, as well as other entities requesting the services. For an entity, as well as individual users where applicable, wanting to setup an ephemeral digital wallet and wallet address, the entity may first access the online service provider and request establishment of an account. An account and/or corresponding authentication information with a service provider may be established by providing account details, such as a login, password (or other authentication credential, such as a biometric fingerprint, retinal scan, etc.), and other account creation details. The account creation details may include identification information to establish the account, such as personal information for a user, business or merchant information for an entity, or other types of identification information including a name, address, and/or other information.

The entity may be required to provide financial information, including payment card (e.g., credit/debit card) information, bank account information, gift card information, benefits/incentives, and/or financial investments. This information may be used to process transactions for items and/or services including cryptocurrency purchases from fiat currency, cryptocurrency trading, and the like. In some embodiments, the account creation may establish account funds and/or values, such as by transferring fiat currency, virtual currency, and/or cryptocurrency into the account and/or establishing a credit limit and corresponding credit value that is available to the account and/or card. This may include loading cryptocurrency to the account, digital wallet, and/or online cryptocurrency exchange or another platform, as well as integrating another cryptocurrency wallet (e.g., an offline cold wallet and/or wallet on another cryptocurrency exchange platform). The online payment provider may provide digital wallet services, which may offer financial services to send, store, and receive money, process financial instruments, and/or provide transaction histories, including tokenization of digital wallet data for transaction processing. The application or website of the service provider, such as PAYPAL® or other online payment provider, may provide payments and other transaction processing services. Once the account of the user is established with the service provider, the user may utilize the account via one or more computing devices, such as a personal computer, tablet computer, mobile smart phone, or the like.

A user may utilize cryptocurrency and a digital cryptocurrency wallet to process payments through a blockchain protocol and network associated with the cryptocurrency. For example, a user may make a cryptocurrency payment to another user or otherwise transfer cryptocurrency between digital wallets, nodes, or users, which transfers ownership of the cryptocurrency. When persisting the transaction to a digital ledger associated with the blockchain protocol, miners may be used to verify the transaction, broadcast on the network, and cause the transaction to be recorded in a block on the corresponding blockchain. For example, with a cryptocurrency such as Bitcoin, transactions and Bitcoin transfers require resolution by updating blocks in a distributed ledger on a distributed blockchain network over many computing devices, nodes, servers, and the like. Each block may refer to a ledger record or block that is designed to record the transaction on the distributed ledger for proof of the transactions. Miners may be used to verify and record the individual blocks on the blockchain, which requires time, computing resources, and network bandwidth to broadcast and verify the transactions on recipient nodes after computing some value, such as a nonce. Thus, each block requires a proof of work, which is used to verify and accept each block on the blockchain network.

Where the transaction processor acts as the digital wallet provider and/or cryptocurrency exchange platform on behalf of the entity (e.g., a hot wallet provider holding digital assets on behalf of the user), the transaction processor may provide an ephemeral wallet digital platform where a governor function may control incoming and outgoing cryptocurrency transactions using a whitelist implemented programmatically (e.g., using an application programming interface (API) for a whitelist application and/or software process) and/or with an on-chain smart contract. In order to request a payment of cryptocurrency from the digital wallet (e.g., an outgoing cryptocurrency transaction or withdrawal), a user or entity may be required to provide a digital wallet address on an authorized whitelist of addresses or other list of approved addresses. This may also be limited to an amount of outgoing cryptocurrency. In other embodiments, the user or entity may verify, provide, and/or authenticate their identity with the digital platform, or provide a code or other proof that the outgoing transaction and payment is authorized.

With incoming transactions and/or deposits of cryptocurrency, the digital wallet platform may utilize the governor function to identify a sender digital wallet address and/or identification of the sender with the deposit, and compare that information to the whitelist of approved depositors and/or senders of cryptocurrency. If authorized, the deposit may be allowed. However, if unauthorized, the deposit may be refused and the cryptocurrency returned to the digital address by either not approving the transfer and signing the digital record or implementing another transfer and transaction to return the cryptocurrency through a new ledger record. Control of the digital wallet and address in this manner may be performed for a period of time, and further after the time period ends, the digital wallet may be “zipped up” or closed such that all incoming and/or outgoing cryptocurrency transactions associated with the closed digital wallet are refused, declined, or prevented. In this manner, the transaction processor may enable users and entities to conduct transactions with a limited use and/or ephemeral digital wallet, which provides more efficient and secure processing of cryptocurrency and use of blockchain protocols in a limited manner and scope not permitted by conventional blockchain technologies. This further improves the blockchain and cryptocurrency protocols that utilize different digital wallets and addresses for different purposes and intents.

Implementations of the present disclosure will now be described in detail with reference to the accompanying Figures. It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

### Computing Architecture

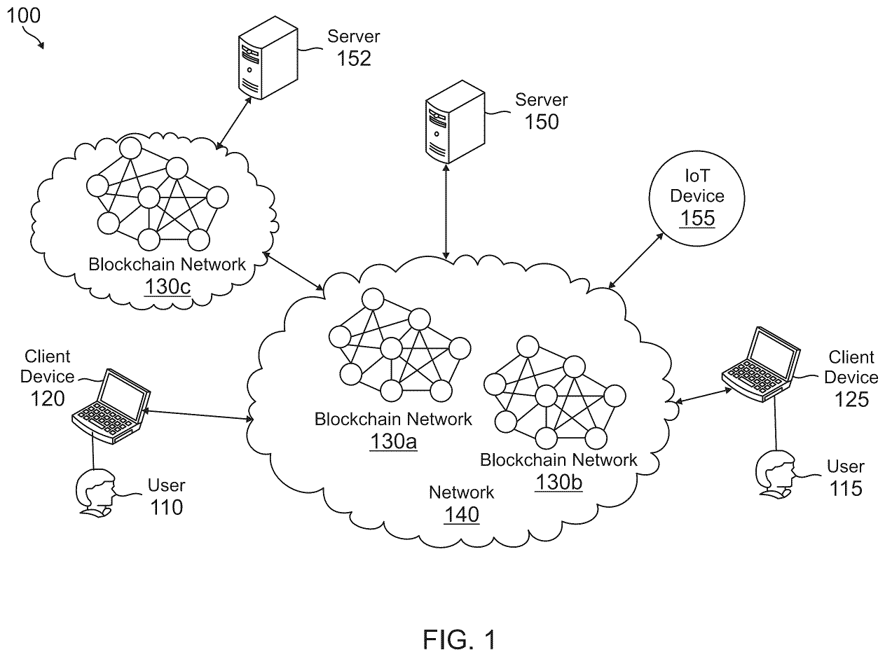

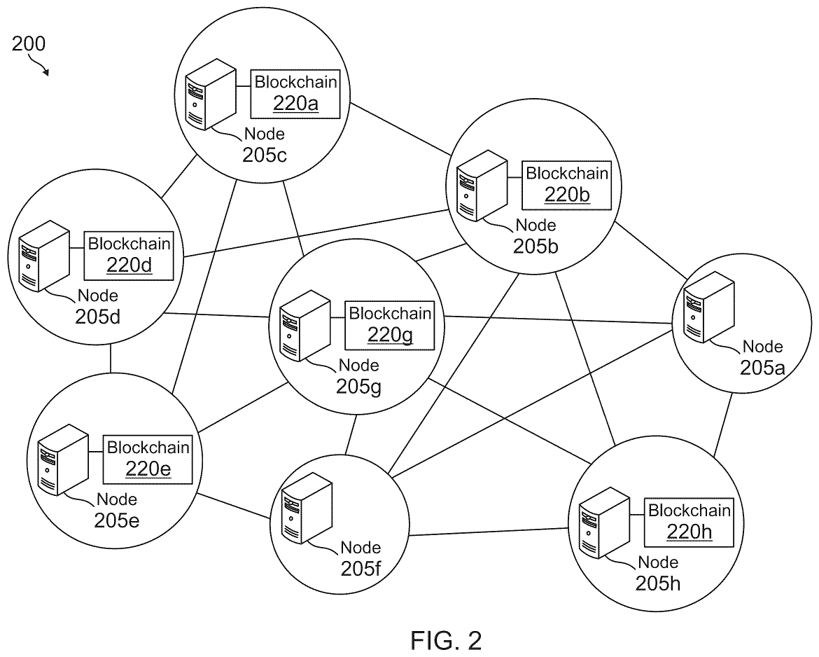

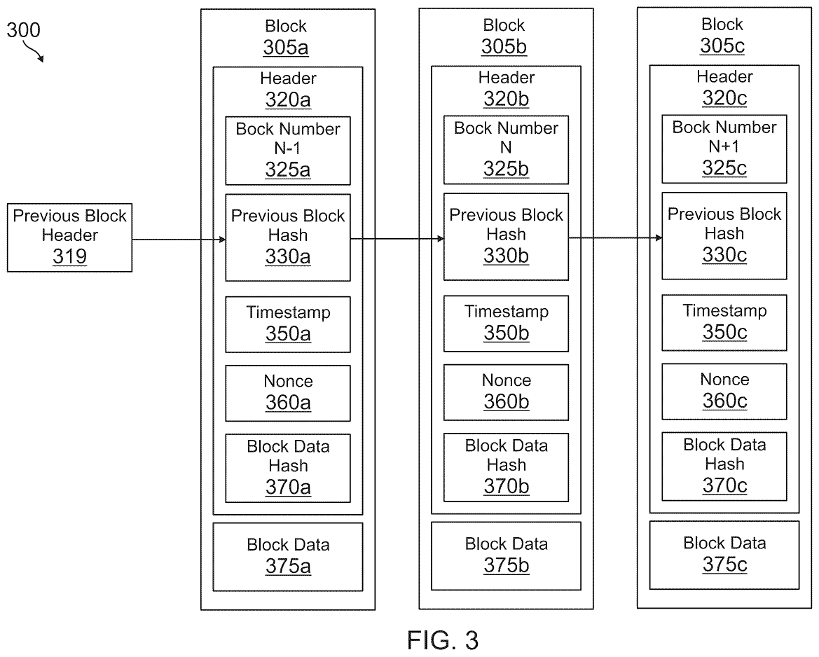

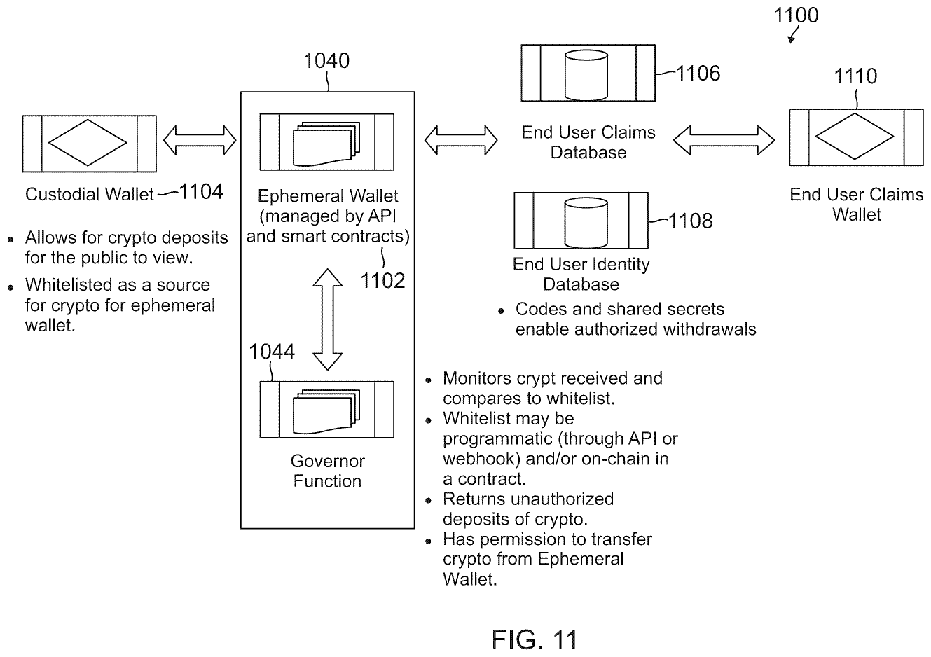

As discussed above, the distributed ledger in a blockchain framework is stored, maintained, and updated in a peer-to-peer network. In one example the distributed ledger maintains a number of blockchain transactions. FIG. 1 shows an example system 100 for facilitating a blockchain transaction. The system 100 includes a first client device 120, a second client device 125, a first server 150, a second server 152, and an Internet of Things (IoT) device 155 interconnected via a network 140. The first client device 120, the second client device 125, the first server 150, and/or the second server 152 may be a computing device 1105 described in more detail with reference to FIG. 11. The IoT device 155 may comprise any of a variety of devices including vehicles, home appliances, embedded electronics, software, sensors, actuators, thermostats, light bulbs, door locks, refrigerators, RFID implants, RFID tags, pacemakers, wearable devices, smart home devices, cameras, trackers, pumps, POS devices, and stationary and mobile communication devices along with connectivity hardware configured to connect and exchange data. The network 140 may be any of a variety of available networks, such as the Internet, and represents a worldwide collection of networks and gateways to support communications between devices connected to the network 140. The system 100 may also comprise one or more distributed or peer-to-peer (P2P) networks, such as a first, second, and third blockchain networks 130a-c (generally referred to as blockchain networks 130). As shown in FIG. 1, the network 140 may comprise the first and second blockchain networks 130a and 130b. The third blockchain network 130c may be associated with a private blockchain as described below with reference to FIG. 2 and is connected to one or more servers, such as the server 152, and is thus, shown separately from the first and second blockchain networks 130a and 103b. Each blockchain network 130 may comprise a plurality of interconnected devices (or nodes) as described in more detail with reference to FIG. 2. As discussed above, a ledger, or blockchain, is a distributed database for maintaining a growing list of records comprising any type of information. A blockchain, as described in more detail with reference to FIG. 3, may be stored at least at multiple nodes (or devices) of the one or more blockchain networks 130.

In one example, a blockchain based transaction may generally involve a transfer of data or value between entities, such as the first user 110 of the first client device 120 and the second user 115 of the second client device 125 in FIG. 1. Each of the servers 150 and 152 may include one or more applications, for example, a transaction application configured to facilitate the transaction between the entities by utilizing a blockchain associated with one of the blockchain networks 130. As an example, the first user 110 may request or initiate a transaction with the second user 115 via a user application executing on the first client device 120. The transaction may be related to a transfer of value or data from the first user 110 to the second user 115. The first client device 120 may send a request of the transaction to the server 150. The first server 150 and/or the second server 152 may send the requested transaction to one of the blockchain networks 130 to be validated and approved as discussed below.

### Blockchain Network

FIG. 2 shows an example blockchain network 200 comprising a plurality of interconnected nodes or devices 205a-h (generally referred to as nodes 205). Each of the nodes 205 may comprise a computing device 1105 described in more detail with reference to FIG. 11. Although FIG. 2 shows a single device 205, each of the nodes 205 may comprise a plurality of devices (e.g., a pool). The blockchain network 200 may be associated with one or more blockchains 220a-h (generally referred to as blockchain 220). Some or all of the nodes 205 may replicate and save an identical copy of the blockchain 220. For example, FIG. 3 shows that the nodes 205b-e and 205g-h store copies of the blockchain 220. The nodes 205b-e and 205g-h may independently update their respective copies of the blockchain 220 as discussed below.

### Blockchain Node Types

Blockchain nodes, for example, the nodes 205, may be full nodes or lightweight nodes. Full nodes, such as the nodes 205b-e and 205g-h, may act as a server in the blockchain network 200 by storing a copy of the entire blockchain 220 and ensuring that transactions posted to the blockchain 220 are valid. The full nodes 205b-e and 205g-h may publish new blocks on the blockchain 220. Lightweight nodes, such as the nodes 205a and 205f, may have fewer computing resources than full nodes. For example, IoT devices often act as lightweight nodes. The lightweight nodes may communicate with other nodes 205, provide the full nodes 205b-e and 205g-h with information, and query the status of a block of the blockchain 220 stored by the full nodes 205b-e and 205g-h. In this example, however, as shown in FIG. 2, the lightweight nodes 205a and 205f may not store a copy of the blockchain 220 and thus, may not publish new blocks on the blockchain 220.

### Blockchain Network Types

The blockchain network 200 and its associated blockchain 220 may be public (permissionless), federated or consortium, or private. If the blockchain network 200 is public, then any entity may read and write to the associated blockchain 220. However, the blockchain network 200 and its associated blockchain 220 may be federated or consortium if controlled by a single entity or organization. Further, any of the nodes 205 with access to the Internet may be restricted from participating in the verification of transactions on the blockchain 220. The blockchain network 200 and its associated blockchain 220 may be private (permissioned) if access to the blockchain network 200 and the blockchain 220 is restricted to specific authorized entities, for example organizations or groups of individuals. Moreover, read permissions for the blockchain 220 may be public or restricted while write permissions may be restricted to a controlling or authorized entity.

### Blockchain

As discussed above, a blockchain 220 may be associated with a blockchain network 200. FIG. 3 shows an example blockchain 300. The blockchain 300 may comprise a plurality of blocks 305a, 305b, and 305c (generally referred to as blocks 305). The blockchain 300 comprises a first block (not shown), sometimes referred to as the genesis block. Each of the blocks 305 may comprise a record of one or a plurality of submitted and validated transactions. The blocks 305 of the blockchain 300 may be linked together and cryptographically secured. In some cases, the post-quantum cryptographic algorithms that dynamically vary over time may be utilized to mitigate ability of quantum computing to break present cryptographic schemes. Examples of the various types of data fields stored in a blockchain block are provided below. A copy of the blockchain 300 may be stored locally, in the cloud, on grid, for example by the nodes 205b-e and 205g-h, as a file or in a database.

### Blocks

Each of the blocks 305 may comprise one or more data fields. The organization of the blocks 305 within the blockchain 300 and the corresponding data fields may be implementation specific. As an example, the blocks 305 may comprise a respective header 320a, 320b, and 320c (generally referred to as headers 320) and block data 375a, 375b, and 375c (generally referred to as block data 375). The headers 320 may comprise metadata associated with their respective blocks 305. For example, the headers 320 may comprise a respective block number 325a, 325b, and 325c. As shown in FIG. 3, the block number 325a of the block 305a is N−1, the block number 325b of the block 305b is N, and the block number 325c of the block 305c is N+1. The headers 320 of the blocks 305 may include a data field comprising a block size (not shown).

The blocks 305 may be linked together and cryptographically secured. For example, the header 320b of the block N (block 305b) includes a data field (previous block hash 330b) comprising a hash representation of the previous block N−1's header 320a. The hashing algorithm utilized for generating the hash representation may be, for example, a secure hashing algorithm 256 (SHA-256) which results in an output of a fixed length. In this example, the hashing algorithm is a one-way hash function, where it is computationally difficult to determine the input to the hash function based on the output of the hash function. Additionally, the header 320c of the block N+1 (block 305c) includes a data field (previous block hash 330c) comprising a hash representation of block N's (block 305b) header 320b.

The headers 320 of the blocks 305 may also include data fields comprising a hash representation of the block data, such as the block data hash 370a-c. The block data hash 370a-c may be generated, for example, by a Merkle tree and by storing the hash or by using a hash that is based on all of the block data. The headers 320 of the blocks 305 may comprise a respective nonce 360a, 360b, and 360c. In some implementations, the value of the nonce 360a-c is an arbitrary string that is concatenated with (or appended to) the hash of the block. The headers 320 may comprise other data, such as a difficulty target.

The blocks 305 may comprise a respective block data 375a, 375b, and 375c (generally referred to as block data 375). The block data 375 may comprise a record of validated transactions that have also been integrated into the blockchain 200 via a consensus model (described below). As discussed above, the block data 375 may include a variety of different types of data in addition to validated transactions. Block data 375 may include any data, such as text, audio, video, image, or file, that may be represented digitally and stored electronically.

### Blockchain Transaction

In one example, a blockchain based transaction may generally involve a transfer of data or value or an interaction between entities and described in more detail below. Referring back to FIG. 1, the first server 150 and/or the second server 152 may include one or more applications, for example, a transaction application configured to facilitate a blockchain transaction between entities. The entities may include users, devices, etc. The first user 110 may request or initiate a transaction with the second user 115 via a user application executing on the first client device 120. The transaction may be related to a transfer of value or data from the first user 110 to the second user 115. The value or data may represent money, a contract, property, records, rights, status, supply, demand, alarm, trigger, or any other asset that may be represented in digital form. The transaction may represent an interaction between the first user 110 and the second user 115.

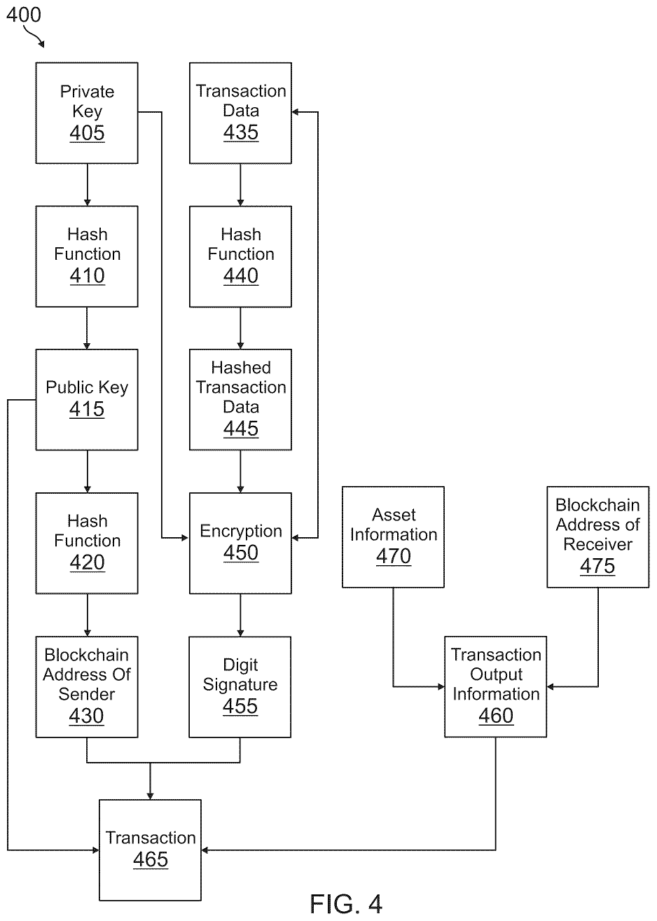

FIG. 4 is a diagram of a transaction 465 generated by the transaction application. The transaction 465 may include a public key 415, a blockchain address 430 associated with the first user 110, a digital signature 455, and transaction output information 460. The transaction application may derive a public key 415 from a private key 405 of the first user 110 by applying a cryptographic hash function 410 to the private key 405. The cryptographic hash function 410 may be based on AES, SHA-2, SHA-3, RSA, ECDSA, ECDH (elliptic curve cryptography), or DSA (finite field cryptography), although other cryptographic models may be utilized. More information about cryptographic algorithms may be found in Federal Information Processing Standards Publication (FIPS PUB 180-3), Secure Hash Standard. The transaction application may derive an address or identifier for the first user 110, such as the blockchain address 430, by applying a hash function 420 to the public key 415. Briefly, a hash function is a function that may be used for mapping arbitrary size data to fixed size data. The value may also be referred to as a digest, a hash value, a hash code, or a hash. In order to indicate that the first user 110 is the originator of the transaction 465, the transaction application may generate the digital signature 455 for the transaction data 435 using the private key 405 of the first user 110. The transaction data 435 may include information about the assets to be transferred and a reference to the sources of the assets, such as previous transactions in which the assets were transferred to the first user 110 or an identification of events that originated the assets. Generating the digital signature 455 may include applying a hash function 440 to the transaction data 435 resulting in hashed transaction data 445. The hashed transaction data 445 and the transaction data 435 may be encrypted (via an encryption function 450) using the private key 405 of the first user 110 resulting in the digital signature 455. The transaction output information 460 may include asset information 470 and an address or identifier for the second user 115, such as the blockchain address 475. The transaction 465 may be sent from the first client device 125 to the first server 150.

The specific type of cryptographic algorithm being utilized may vary dynamically based on various factors, such as a length of time, privacy concerns, etc. For example, the type of cryptographic algorithm being utilized may be changed yearly, weekly, daily, etc. The type of algorithms may also change based on varying levels of privacy. For example, an owner of content may implement a higher level of protection or privacy by utilizing a stronger algorithm.

### Blockchain Addresses

A blockchain network may utilize blockchain addresses to indicate an entity using the blockchain or start and end points in the transaction. For example, a blockchain address for the first user 110, shown in FIG. 4 as the blockchain address of sender 430, may include an alphanumeric string of characters derived from the public key 415 of the first user 110 based on applying a cryptographic hash function 420 to the public key 415. The methods used for deriving the addresses may vary and may be specific to the implementation of the blockchain network. In some examples, a blockchain address may be converted into a QR code representation, barcode, token, or other visual representations or graphical depictions to enable the address to be optically scanned by a mobile device, wearables, sensors, cameras, etc. In addition to an address or QR code, there are many ways of identifying individuals, objects, etc. represented in a blockchain. For example, an individual may be identified through biometric information such as a fingerprint, retinal scan, voice, facial id, temperature, heart rate, gestures/movements unique to a person etc., and through other types of identification information such as account numbers, home address, social security number, formal name, etc.

### Broadcasting Transaction

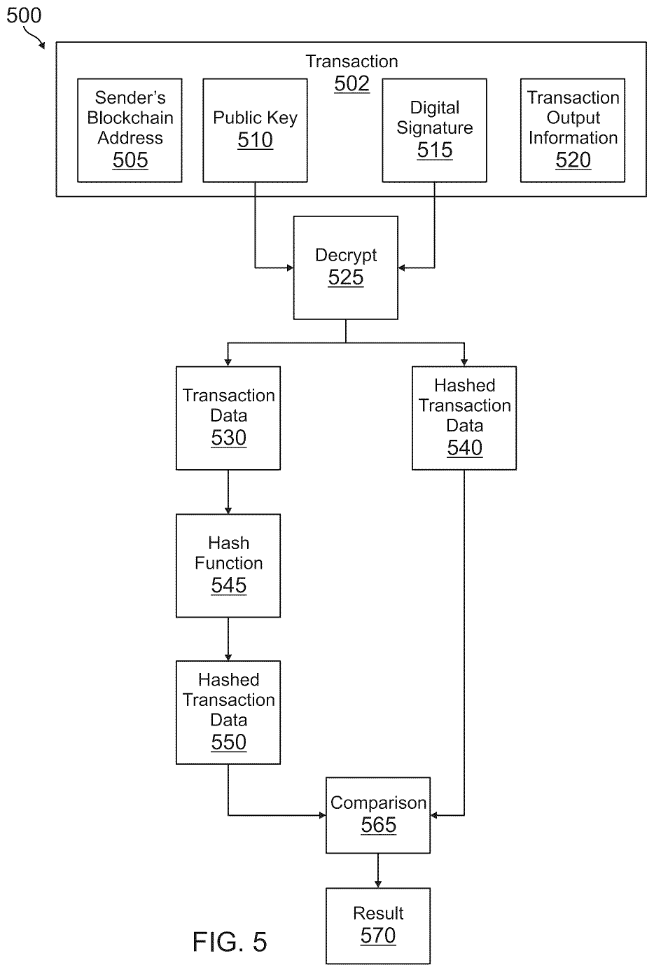

The first server 150 may receive transactions from users of the blockchain network 130. The transactions may be submitted to the first server 150 via desktop applications, smartphone applications, digital wallet applications, web services, or other software applications. The first server 150 may send or broadcast the transactions to the blockchain network 130. FIG. 5 shows an example transaction 502 broadcast by the server 150 to the blockchain network 130. The transaction 502 may be broadcast to multiple nodes 205 of the blockchain network 130. Typically, once the transaction 502 is broadcast or submitted to the blockchain network 130, it may be received by one or more of the nodes 205. Once the transaction 502 is received by the one or more nodes 205 of the blockchain network 130, it may be propagated by the receiving nodes 205 to other nodes 205 of the blockchain network 130.

A blockchain network may operate according to a set of rules. The rules may specify conditions under which a node may accept a transaction, a type of transaction that a node may accept, a type of compensation that a node receives for accepting and processing a transaction, etc. For example, a node may accept a transaction based on a transaction history, reputation, computational resources, relationships with service providers, etc. The rules may specify conditions for broadcasting a transaction to a node. For example, a transaction may be broadcasted to one or more specific nodes based on criteria related to the node's geography, history, reputation, market conditions, docket/delay, technology platform. The rules may be dynamically modified or updated (e.g., turned on or off) to address issues such as latency, scalability and security conditions. A transaction may be broadcast to a subset of nodes as a form of compensation to entities associated with those nodes (e.g., through receipt of compensation for adding a block of one or more transactions to a blockchain).

### Transaction Validation—User Authentication and Transaction Data Integrity

Not all the full nodes 205 may receive the broadcasted transaction 502 at the same time, due to issues such as latency. Additionally, not all of the full nodes 205 that receive the broadcasted transaction 502 may choose to validate the transaction 502. A node 205 may choose to validate specific transactions, for example, based on transaction fees associated with the transaction 502. The transaction 502 may include a blockchain address 505 for the sender, a public key 510, a digital signature 515, and transaction output information 520. The node 205 may verify whether the transaction 502 is legal or conforms to a pre-defined set of rules. The node 205 may also validate the transaction 502 based on establishing user authenticity and transaction data integrity. User authenticity may be established by determining whether the sender indicated by the transaction 502 is in fact the actual originator of the transaction 502. User authenticity may be proven via cryptography, for example, asymmetric-key cryptography using a pair of keys, such as a public key and a private key. Additional factors may be considered when establishing user authenticity, such as user reputation, market conditions, history, transaction speed, etc. Data integrity of the transaction 502 may be established by determining whether the data associated with the transaction 502 was modified in any way. Referring back to FIG. 4, when the transaction application creates the transaction 465, it may indicate that the first user 110 is the originator of the transaction 465 by including the digital signature 455.

The node 205 may decrypt the digital signature 515 using the public key 510. A result of the decryption may include hashed transaction data 540 and transaction data 530. The node 205 may generate hashed transaction data 550 based on applying a hash function 545 to the transaction data 530. The node 205 may perform a comparison 565 between the first hashed transaction data 540 and the second hashed transaction data 550. If the result 570 of the comparison 565 indicates a match, then the data integrity of the transaction 502 may be established and node 205 may indicate that the transaction 502 has been successfully validated. Otherwise, the data of the transaction 502 may have been modified in some manner and the node 205 may indicate that the transaction 502 has not been successfully validated.

Each full node 205 may build its own block and add validated transactions to that block. Thus, the blocks of different full nodes 205 may comprise different validated transactions. As an example, a full node 205a may create a first block comprising transactions “A,” “B,” and “C.” Another full node 205b may create a second block comprising transactions “C,” “D,” and “E.” Both blocks may include valid transactions. However, only one block may get added to the blockchain, otherwise the transactions that the blocks may have in common, such as transaction “C” may be recorded twice leading to issues such as double-spending when a transaction is executed twice. One problem that may be seen with the above example is that transactions “C,” “D,” and “E” may be overly delayed in being added to the blockchain. This may be addressed a number of different ways as discussed below.

### Securing Keys

Private keys, public keys, and addresses may be managed and secured using software, such as a digital wallet. Private keys may also be stored and secured using hardware. The digital wallet may also enable the user to conduct transactions and manage the balance. The digital wallet may be stored or maintained online or offline, and in software or hardware or both hardware and software. Without the public/private keys, a user has no way to prove ownership of assets. Additionally, anyone with access a user's public/private keys may access the user's assets. While the assets may be recorded on the blockchain, the user may not be able to access them without the private key.

### Tokens

A token may refer to an entry in the blockchain that belongs to a blockchain address. The entry may comprise information indicating ownership of an asset. The token may represent money, a contract, property, records, access rights, status, supply, demand, alarm, trigger, reputation, ticket, or any other asset that may be represented in digital form. For example, a token may refer to an entry related to cryptocurrency that is used for a specific purpose or may represent ownership of a real-world asset, such as Fiat currency or real-estate. Token contracts refer to cryptographic tokens that represent a set of rules that are encoded in a smart contract. The person that owns the private key corresponding to the blockchain address may access the tokens at the address. Thus, the blockchain address may represent an identity of the person that owns the tokens. Only the owner of the blockchain address may send the token to another person. The tokens may be accessible to the owner via the owner's wallet. The owner of a token may send or transfer the token to a user via a blockchain transaction. For example, the owner may sign the transaction corresponding to the transfer of the token with the private key. When the token is received by the user, the token may be recorded in the blockchain at the blockchain address of the user.

### Establishing User Identity

While a digital signature may provide a link between a transaction and an owner of assets being transferred, it may not provide a link to the real identity of the owner. In some cases, the real identity of the owner of the public key corresponding to the digital signature may need to be established. The real identity of an owner of a public key may be verified, for example, based on biometric data, passwords, personal information, etc. Biometric data may comprise any physically identifying information such as fingerprints, face and eye images, voice sample, DNA, human movement, gestures, gait, expressions, heart rate characteristics, temperature, etc.

### Publishing and Validating a Block

As discussed above, full nodes 205 may each build their own blocks that include different transactions. A node may build a block by adding validated transactions to the block until the block reaches a certain size that may be specified by the blockchain rules. However, only one of the blocks may be added to the blockchain. The block to be added to the blockchain and the ordering of the blocks may be determined based on a consensus model. In a proof of work model, both nodes may compete to add their respective block to the blockchain by solving a complex mathematical puzzle. For example, such a puzzle may include determining a nonce, as discussed above, such that a hash (using a predetermined hashing algorithm) of the block to be added to the blockchain (including the nonce) has a value that meets a range limitation. If both nodes solve the puzzle at the same time, then a “fork” may be created. When a full node 205 solves the puzzle, it may publish its block to be validated by the validation nodes 205 of the blockchain network 130.

In a proof of work consensus model, a node validates a transaction, for example, by running a check or search through the current ledger stored in the blockchain. The node will create a new block for the blockchain that will include the data for one or more validated transactions (see, e.g., block 375 of FIG. 3). In a blockchain implementation such as Bitcoin, the size of a block is constrained. Referring back to FIG. 3, in this example, the block will include a Previous Block Hash 330 representing a hash of what is currently the last block in the blockchain. The block may also include a hash 370 of its own transaction data (e.g., a so-called Merkle hash). According to a particular algorithm, all or selected data from the block may be hashed to create a final hash value. According to an embodiment of the proof of work model, the node will seek to modify the data of the block so that the final hash value is less than a preset value. This is achieved through addition of a data value referred to as a nonce 360. Because final hash values cannot be predicted based on its input, it is not possible to estimate an appropriate value for the nonce 360 that will result in a final hash value that is less than the pre-set value. Accordingly, in this embodiment, a computationally-intensive operation is needed at the node to determine an appropriate nonce value through a “brute force” trial-and-error method. Once a successful nonce value is determined, the completed block is published to the blockchain network for validation. If validated by a majority of the nodes in the blockchain network, the completed block is added to the blockchain at each participating node. When a node's block is not added to the blockchain, the block is discarded and the node proceeds to build a new block. The transactions that were in the discarded block may be returned to a queue and wait to be added to a next block. When a transaction is discarded or returned to the queue, the assets associated with the discarded transaction are not lost, since a record of the assets will exist in the blockchain. However, when a transaction is returned to the queue, it causes a delay in completing the transaction. Reducing the time to complete a transaction may be important. A set of blockchain rules, or renumeration/compensation for a node to process the returned transaction may determine how a returned transaction is to be treated going forward. When a transaction is put into a pool then it can have a priority level but then a rule may indicate that the transaction priority level must exceed a threshold level. The priority level of a returned or discarded transaction may be increased. Another way to reduce the time to complete a transaction is to have the system, service provider, participant in the transaction, or merchant pay additional incentive for nodes to process a returned transaction. As an example, a service provider may identify a network of preferred miners based on geography or based on a volume discount perspective. The time to complete a transaction may be optimized by routing a returned transaction to specific preferred nodes. A transaction may be associated with an address that limits which of the preferred nodes will get to process the transaction if it is returned due to its inclusion in a discarded block. A value may be associated with the transaction so that it goes to preferred miners in a specific geographic location. Additionally, returned transactions may be processed based on pre-set rules. For example, a rule may indicate a commitment to process a specific number of returned transactions to receive additional incentive or compensation.

### Blockchain Confirmations

After a block comprising a transaction is added to a blockchain, a blockchain confirmation may be generated for the transaction. The blockchain confirmation may be a number of blocks added to the blockchain after the block that includes the transaction. For example, when a transaction is broadcasted to the blockchain, there will be no blockchain confirmations associated with the transaction. If the transaction is not validated, then the block comprising the transaction will not be added to the blockchain and the transaction will continue to have no blockchain confirmations associated with it. However, if a block comprising the transaction is validated, then each of the transactions in the block will have a blockchain confirmation associated with the transaction. Thus, a transaction in a block will have one blockchain confirmation associated with it when the block is validated. When the block is added to the blockchain, each of the transactions in the block will have two blockchain confirmations associated with it. As additional validated blocks are added to the blockchain, the number of blockchain confirmations associated with the block will increase. Thus, the number of blockchain confirmations associated with a transaction may indicate a difficulty of overwriting or reversing the transaction. A higher valued transaction may require a larger number of blockchain confirmations before the transaction is executed.

### Consensus Models

As discussed above, a blockchain network may determine which of the full nodes 205 publishes a next block to the blockchain. In a permissionless blockchain network, the nodes 205 may compete to determine which one publishes the next block. A node 205 may be selected to publish its block as the next block in the blockchain based on consensus model. For example, the selected or winning node 205 may receive a reward, such as a transaction fee, for publishing its block, for example. Various consensus models may be used, for example, a proof of work model, a proof of stake model, a delegated proof of stake model, a round robin model, proof of authority or proof of identity model, and proof of elapsed time model.

In a proof of work model, a node may publish the next block by being the first to solve a computationally intensive mathematical problem (e.g., the mathematical puzzle described above). The solution serves as “proof” that the node expended an appropriate amount of effort in order to publish the block. The solution may be validated by the full nodes before the block is accepted. The proof of work model, however, may be vulnerable to a 51% attack described below. The proof of stake model is generally less computationally intensive than the proof of work model. Unlike the proof of work model which is open to any node having the computational resources for solving the mathematical problem, the proof of stake model is open to any node that has a stake in the system. The stake may be an amount of cryptocurrency that the blockchain network node (user) may have invested into the system. The likelihood of a node publishing the next block may be proportional to its stake. Since this model utilizes fewer resources, the blockchain may forego a reward as incentive for publishing the next block. The round robin model is generally used by permissioned blockchain networks. Using this model, nodes may take turns to publish new blocks. In the proof of elapsed time model, each publishing node requests a wait time from a secure hardware within their computer system. The publishing node may become idle for the duration of the wait time and then creates and publishes a block to the blockchain network. As an example, in cases where there is a need for speed and/or scalability (e.g. in the context of a corporate environment), a hybrid blockchain network may switch to be between completely or partially permissioned and permissionless. The network may switch based on various factors, such as latency, security, market conditions, etc.

### Forks

As discussed above, consensus models may be utilized for determining an order of events on a blockchain, such as which node gets to add the next block and which node's transaction gets verified first. When there is a conflict related to the ordering of events, the result may be a fork in the blockchain. A fork may cause two versions of the blockchain to exist simultaneously. Consensus methods generally resolve conflicts related to the ordering of events and thus, prevent forks from occurring. In some cases, a fork may be unavoidable. For example, with a proof of work consensus model, only one of the nodes competing to solve a puzzle may win by solving its puzzle first. The winning node's block is then validated by the network. If the winning node's block is successfully validated by the network, then it will be the next block added to the blockchain. However, it may be the case that two nodes may end up solving their respective puzzles at the same time. In such a scenario, the blocks of both winning nodes may be broadcasted to the network. Since different nodes may receive notifications of a different winning node, the nodes that receive notification of the first node as the winning node may add the first node's block to their copy of the blockchain. Nodes that receive notification of the second node as the winning node may add the second node's block to their copy of the blockchain. This results in two versions of the blockchain or a fork. This type of fork may be resolved by the longest chain rule of the proof of work consensus model. According to the longest chain rule, if two versions of the blockchain exist, then the network the chain with a larger number of blocks may be considered to be the valid blockchain. The other version of the blockchain may be considered as invalid and discarded or orphaned. Since the blocks created by different nodes may include different transactions, a fork may result in a transaction being included in one version of the blockchain and not the other. The transactions that are in a block of a discarded blockchain may be returned to a queue and wait to be added to a next block.

In some cases, forks may result from changes related to the blockchain implementation, for example, changes to the blockchain protocols and/or software. Forks may be more disruptive for permissionless and globally distributed blockchain networks than for private blockchain networks due to their impact on a larger number of users. A change or update to the blockchain implementation that is backwards compatible may result in a soft fork. When there is a soft fork, some nodes may execute the update blockchain implementation while other nodes may not. However, nodes that do not update to the new blockchain implementation may continue to transact with updated nodes.

A change to the blockchain implementation that is not backwards compatible may result in a hard fork. While hard forks are generally intentional, they may also be caused by unintentional software bugs/errors. In such a case, all publishing nodes in the network may need to update to the new blockchain implementation. While publishing nodes that do not update to the new blockchain implementation may continue to publish blocks according to the previous blockchain implementation, these publishing nodes may reject blocks created based on the new blockchain implementation and continue to accept blocks created based on the previous blockchain implementation. Therefore, nodes on different hard fork versions of the blockchain may not be able to interact with one another. If all nodes move to the new blockchain implementation, then the previous version may be discarded or abandoned. However, it may not be practical or feasible to update all nodes in the network to a new blockchain implementation, for example, if the update invalidates specialized hardware utilized by some nodes.

### Blockchain-Based Application: Cryptocurrency

Cryptocurrency is a medium of exchange that may be created and stored electronically in a blockchain, such as a the blockchain 130a in FIG. 1. Bitcoin is one example of cryptocurrency, however there are several other cryptocurrencies. Various encryption techniques may be used for creating the units of cryptocurrency and verifying transactions. As an example, the first user 110 may own 10 units of a cryptocurrency. The blockchain 130a may include a record indicating that the first user 110 owns the 10 units of cryptocurrency. The first user 110 may initiate a transfer of the 10 units of cryptocurrency to the second user 115 via a wallet application executing on the first client device 120. The wallet application may store and manage a private key of the first user 110. Examples of the wallet device include a personal computer, a laptop computer, a smartphone, a personal data assistant (PDA), etc.

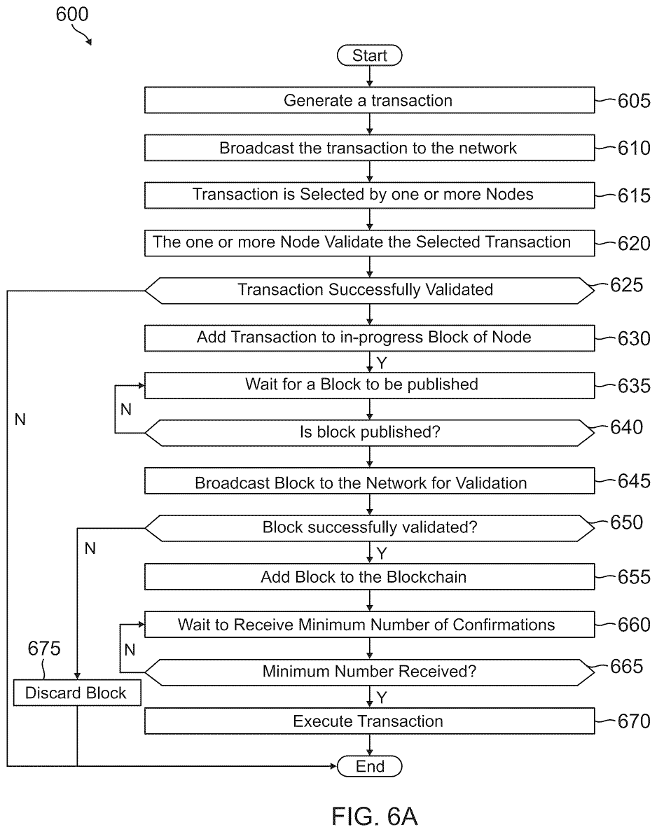

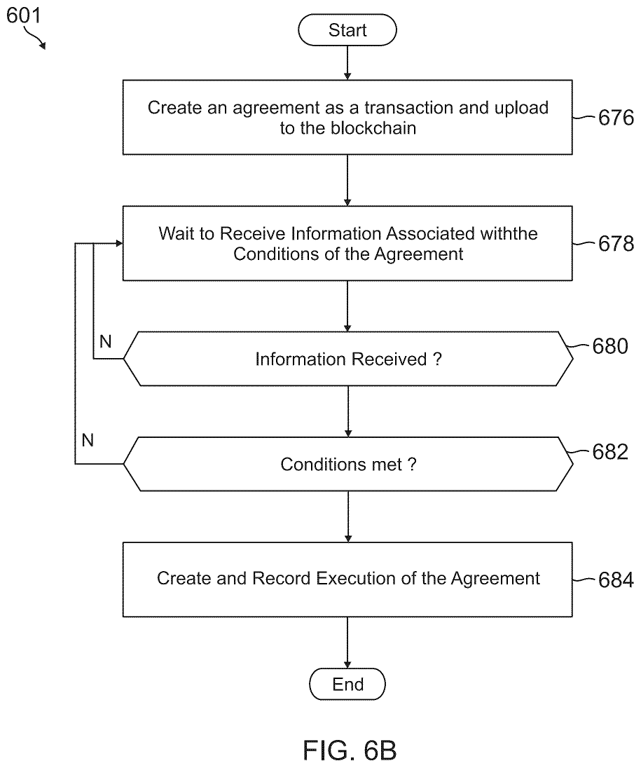

FIG. 6A is a flow diagram showing steps of an example method 600 for performing a blockchain transaction between entities, such as the first user 110 of the first client device 120 and the second user 115 of the second client device 125 in FIG. 1. The steps of the method 600 may be performed by any of the computing devices shown in FIG. 1. Alternatively or additionally, some or all of the steps of the method 600 may be performed by one or more other computing devices. Steps of the method 600 may be modified, omitted, and/or performed in other orders, and/or other steps added.

At step 605, the wallet application may generate transaction data for transferring the 10 units of cryptocurrency from the first user 110 to the second user 120. The wallet application may generate a public key for the transaction using the private key of the first user 110. In order to indicate that the first user 110 is the originator of the transaction, a digital signature may also be generated for the transaction using the private key of the first user 110. As discussed with reference to FIG. 4, the transaction data may include information, such as a blockchain address of the sender 430, the digital signature 455, transaction output information 460, and the public key of the sender 415. The transaction data may be sent to the first server 150 from the first client device 125.

The first server 150 may receive the transaction data from the first client device 125. At step 610, the first server 150 may broadcast the transaction to the blockchain network 130a. The transaction may be received by one or more nodes 205 of the blockchain network 130a. At step 615, upon receiving the transaction, a node 205 may choose to validate the transaction, for example, based on transaction fees associated with the transaction. If the transaction is not selected for validation by any of the nodes 205, then the transaction may be placed in a queue and wait to be selected by a node 205.

At step 620, each of the nodes 205 that selected the transaction may validate the transaction. Validating the transaction may include determining whether the transaction is legal or conforms to a pre-defined set of rules for that transaction, establishing user authenticity, and establishing transaction data integrity. At step 625, if the transaction is successfully validated by a node 205, the validated transaction is added to a block being constructed by that node 205 (step 630). As discussed above, since different nodes 205 may choose to validate different transactions, different nodes 205 may build or assemble a block comprising different validated transactions. Thus, the transaction associated with the first user 110 transferring 10 units of cryptocurrency to the second user 115 may be included in some blocks and not others.

At step 635, the blockchain network 130a may wait for a block to be published. Validated transactions may be added to the block being assembled by a node 205 until it reaches a minimum size specified by the blockchain. If the blockchain network 130a utilizes a proof of work consensus model, then the nodes 205 may compete for the right to add their respective blocks to the blockchain by solving a complex mathematical puzzle. The node 205 that solves its puzzle first wins the right to publish its block. As compensation, the winning node may be awarded a transaction fee associated with the transaction (e.g., from the wallet of the first user 110). Alternatively, or in addition, the winning node may be awarded compensation as an amount of cryptocurrency added to an account associated with the winning node from the blockchain network (e.g., “new” units of cryptocurrency entering circulation). This latter method of compensation and releasing new units of cryptocurrency into circulation is sometimes referred to as “mining.” At step 640, if a block has not been published, then the process 600 returns to step 635 and waits for a block to be published. However, at step 640, if a block has been published, then the process 600 proceeds to step 645.

At step 645, the published block is broadcast to the blockchain network 130a for validation. At step 650, if the block is validated by a majority of the nodes 205, then at step 655, the validated block is added to the blockchain 220. However, at step 650, if the block is not validated by a majority of the nodes 205, then the process 600 proceeds to step 675. At step 675, the block is discarded and the transactions in the discarded block are returned back to the queue. The transactions in the queue may be selected by one or more nodes 205 for the next block. The node 205 that built the discarded block may build a new next block.

At step 660, if the transaction was added to the blockchain 220, the server 150 may wait to receive a minimum number of blockchain confirmations for the transaction. At step 665, if the minimum number of confirmations for the transaction have not been received, then the process may return to step 660. However, if at step 665, the minimum number of confirmations have been received, then the process proceeds to step 670. At step 670, the transaction may be executed and assets from the first user 110 may be transferred to the second user 115. For example, the 10 units of cryptocurrency owned by the first user 110 may be transferred from a financial account of the first user 110 to a financial account of the second user 115 after the transaction receives at least three confirmations.

### Smart Contracts

A smart contract is an agreement that is stored in a blockchain and automatically executed when the agreement's predetermined terms and conditions are met. The terms and conditions of the agreement may be visible to other users of the blockchain. When the pre-defined rules are satisfied, then the relevant code is automatically executed. The agreement may be written as a script using a programming language such as Java, C++, JavaScript, VBScript, PHP, Perl, Python, Ruby, ASP, Tcl, etc. The script may be uploaded to the blockchain as a transaction on the blockchain.

As an example, the first user 110 (also referred to as tenant 110) may rent an apartment from the second user 115 (also referred to as landlord 115). A smart contract may be utilized between the tenant 110 and the landlord 115 for payment of the rent. The smart contract may indicate that the tenant 110 agrees to pay next month's rent of $1000 by the 28^{th} of the current month. The agreement may also indicate that if the tenant 110 pays the rent, then the landlord 115 provides the tenant 110 with an electronic receipt and a digital entry key to the apartment. The agreement may also indicate that if the tenant 110 pays the rent by the 28^{th} of the current month, then on the last day of the current month, both the entry key and the rent are released respectively to the tenant 110 and the landlord 115.

FIG. 6B is a flow diagram showing steps of an example method 601 for performing a smart contract transaction between entities, such as the tenant 110 and the landlord 115. The steps of the method 601 may be performed by any of the computing devices shown in FIG. 1. Alternatively or additionally, some or all of the steps of the method 601 may be performed by one or more other computing devices. Steps of the method 601 may be modified, omitted, and/or performed in other orders, and/or other steps added.

At step 676, the agreement or smart contract between the tenant 110 and the landlord 115 may be created and then submitted to the blockchain network 130a as a transaction. The transaction may be added to a block that is mined by the nodes 205 of the blockchain network 130a, the block comprising the transaction may be validated by the blockchain network 130a and then recorded in the blockchain 220 (as shown in steps 610-655 in FIG. 6A). The agreement associated with the transaction may be given a unique address for identification.

At step 678, the process 601 waits to receive information regarding the conditions relevant for the agreement. For example, the process 601 may wait to receive notification that $1000 was sent from a blockchain address associated with the tenant 110 and was received at a blockchain address associated with the landlord 115 by the 28th of the current month. At step 680, if such a notification is not received, then the process 601 returns to step 678. However, if at step 680, a notification is received, then the process 601 proceeds to step 682.

At step 682, based on determining that the received notification satisfies the conditions needed to trigger execution of the various terms of the smart contract, the process 601 proceeds to step 684. However, at step 682, if it is determined that the received notification does not satisfy the conditions needed to trigger execution of the smart contract, then the process 601 returns to step 678. At step 684, the process 601 creates and records a transaction associated with execution of the smart contract. For example, the transaction may include information of the payment received, the date the payment was received, an identification of the tenant 110 and an identification of the landlord 115. The transaction may be broadcast to the blockchain network 130a and recorded in the blockchain 220 (as shown in steps 610-655 of the process 600 of FIG. 6A). If the transaction is successfully recorded in the blockchain 220, the transaction may be executed. For example, if the payment was received on the 28th, then an electronic receipt may be generated and sent to the tenant 110. However, on the last day of the current month, both the digital entry key and the rent are released respectively to the tenant 110 and the landlord 115.

Smart contracts may execute based on data received from entities that are not on the blockchain or off-chain resources. For example, a smart contract may be programmed to execute if a temperature reading from a smart sensor or IoT sensor falls below 10 degrees. Smart contracts are unable to pull data from off-chain resources. Instead, such data needs to be pushed to the smart contract. Additionally, even slight variations in data may be problematic since the smart contract is replicated across multiple nodes of the network. For example, a first node may receive a temperature reading of 9.8 degrees and a second node may receive a temperature reading of 10 degrees. Since validation of a transaction is based on consensus across nodes, even small variations in the received data may result in a condition of the smart contract to be evaluated as being not satisfied. Third party services may be utilized to retrieve off-chain resource information and push this to the blockchain. These third-party services may be referred to as oracles. Oracles may be software applications, such as a big data application, or hardware, such as an IoT or smart device. For example, an oracle service may evaluate received temperature readings beforehand to determine if the readings are below 10 degrees and then push this information to the smart contract. However, utilizing oracles may introduce another possible point of failure into the overall process. Oracles may experience errors, push incorrect information or may even go out of business.

Since blockchains are immutable, amending or updating a smart contract that resides in a blockchain may be challenging and thus, more expensive and/or more restrictive than with text-based contracts.

Blockchain Enabled in-Store Purchasing

An example of blockchain enabled in-store purchasing is described with reference to the system 800 shown in FIG. 8, the process 600 shown in FIG. 6A and the process 601 shown in FIG. 6B. FIG. 8 illustrates an example of a blockchain enabled in-store purchase system 800. The system 800 includes a mobile device 805, a merchant system 810, and a server 850 connected via a network 840. The merchant system 810 may be connected via a local wireless network to various IoT devices within a store, for example, an in-store smart shelf 815, and an in-store smart checkout detector 830.

The store may include one or more smart shelves, such as the in-store smart shelf 815. The smart shelf 815 may include an RFID tag, an RFID reader, and an antenna. One or more products may be stored on the in-store smart shelf 815. Each product may include an RFID tag, such as a first product tag 820a attached to a first product 816a and a second product tag 820b attached to a second product 816b. The in-store smart shelf 815 may, based on reading the product tags 820a and 820b, send information about the products 816a and 816b throughout the day to the merchant system 810. The merchant system 810 may in turn update an inventory of products currently within the store.

A shopper may travel through the store with the mobile device 805. A digital shopping list on the mobile device 805 may include a list of items that the shopper may need to purchase. For example, the shopping list may include an item that matches the first product 816a. When the shopper is close to the in-store smart shelf 815, the mobile device 805 may notify the shopper that the first product 816a is currently available on the in-store smart shelf 815. The shopper may remove the first product 816a from the in-store smart shelf 815 and place it into a smart shopping cart 835. The smart shopping cart 835 may read the first product tag 820a as well as the product tags attached to other products that may have been placed in the smart shopping cart 835. When the shopper is ready to checkout, the shopper may walk out of the store with the shopping cart 835. As the shopper walks out of the store, the in-store smart checkout detector 830 may detect the smart shopping cart 835. The smart shopping cart 835 may communicate with the in-store smart checkout detector 830 and transmit information about the products in the smart shopping cart. The in-store smart checkout detector 830 may send information about the products, such as the first product 816a, and payment information from the mobile device 805 to the merchant system 810. The merchant system 810 may receive information from the in-store smart checkout detector 830 and the payment information and proceed to initiate purchase of the first product 816a.

Referring to step 605 of the process 600 shown in FIG. 6A, a wallet application on the mobile device 805 may generate transaction data for transferring an amount of cryptocurrency matching the sale price of the first product 816a from the shopper to the merchant. The wallet application may generate a public key for the transaction using the private key of the shopper. In order to indicate that the shopper is the originator of the transaction, a digital signature may also be generated for the transaction using the private key of the shopper. The transaction data may be sent to the server 850 from the mobile device 805.

The server 850 may receive the transaction data from the mobile device 805. At step 610, the server 850 may broadcast the transaction to the blockchain network 130a. The transaction may be received by one or more nodes 205 of the blockchain network 130a. At step 615, upon receiving the transaction, a node 205 may choose to validate the transaction, for example, based on transaction fees associated with the transaction. If the transaction is not selected for validation by any of the nodes 205, then the transaction may be placed in a queue and wait to be selected by a node 205.

At step 620, each of the nodes 205 that selected the transaction may validate the transaction. At step 625, if the transaction is successfully validated by a node 205, the validated transaction is added, at step 630, to a block being constructed by that node 205. At step 635, the blockchain network 130a may wait for a block to be published. At step 640, if a block has not been published, then the process 600 returns to step 635 and waits for a block to be published. However, at step 640, if a block has been published, then the process 600 proceeds to step 645.

At step 645, the published block is broadcast to the blockchain network 130a for validation. At step 650, if the block is validated by a majority of the nodes 205, then at step 655, the validated block is added to the blockchain 220. At step 660, if the transaction was added to the blockchain 220, the server 850 may wait to receive a minimum number of blockchain confirmations for the transaction. At step 665, if the minimum number of confirmations for the transaction have not been received, then the process may return to step 660. However, if at step 665, the minimum number of confirmations have been received, then the process proceeds to step 670. At step 670, the transaction may be executed and the sale price of the first product 816a may be transferred from the shopper to the merchant.

When the in-store smart checkout detector 830 sends information about the products, such as the first product 816a, and payment information from the mobile device 805 to the merchant system 810, a smart contract may be created between the shopper and the merchant and executed according to the process 601 shown in FIG. 6B. For example, at step 676, a smart contract between the shopper and the merchant may be created and then submitted to the blockchain network 130a as a transaction. For example, at step 678, the process 601 may wait to receive notification that an amount of cryptocurrency equal to the sale price of the first product 816a was sent from a blockchain address associated with the shopper and was received at a blockchain address associated with the merchant by the time the first product 816a is removed from the smart shopping cart 835. If the payment for the first product 816a was successfully transferred from the shopper to the merchant by the time the shopper removes the first product 816a from the smart shopping cart 835, then an electronic receipt may be generated and sent to the shopper. Otherwise, the merchant system 815 may be alerted that the shopper is attempting to leave the premises without paying for the first product 816a.

### Blockchain Enabled In-Vehicle Purchasing

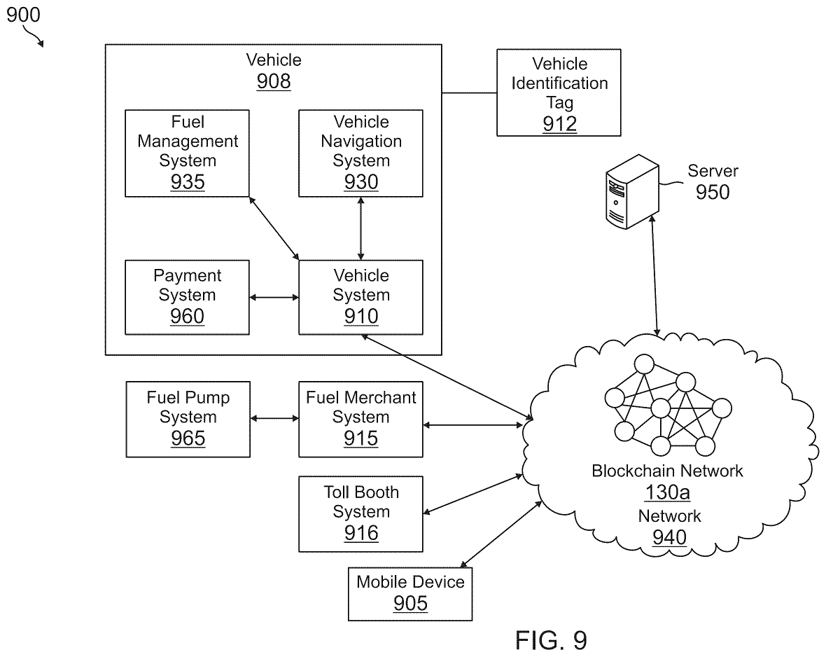

An example of blockchain enabled in-vehicle purchasing is described with reference to the system 900 shown in FIG. 9, the process 600 shown in FIG. 6A and the process 601 shown in FIG. 6B. FIG. 9 illustrates an example system 900 for blockchain enabled in-vehicle purchasing. The system 900 includes an IoT enable smart vehicle 908. The vehicle 908 may include one or more computing devices implementing a vehicle system 910, a vehicle navigation system 930, a payment system 960 and a fuel management system 935. The vehicle 908 may include a RFID tag, such as a vehicle identification tag 912. The system 900 may also include various merchant systems, such as a fuel merchant system 915, and a toll booth system 916. The system 900 may also include a mobile device 905 belonging to a driver of the vehicle 908.

When the driver gets into the vehicle 908, payment information may be loaded from the driver's mobile device 905 into the vehicle payment system 910 so it is available for secure payments to other devices in order to complete in-vehicle purchases, such as in-vehicle purchase of fuel and in-vehicle payment of tolls. The driver of the smart vehicle may pay for parking, fast food, using the IoT enabled smart vehicle 908. Additionally, the IoT enabled smart vehicle 908 may also facilitate in-vehicle purchasing of smartphone apps, music, audio books, and other goods and services.

The fuel management system 935 may perform various functions related to fuel usage and communicate with the vehicle system 916. For example, the fuel management system 935 may monitor fuel usage and based on detecting that the fuel is below a threshold, notify the vehicle system 910. The vehicle system 910 may communicate with the vehicle navigation system 930 to determine nearby fuel stations. The selection of a fuel station to may be based on various factors, such as the availability of fuel at nearby fuel stations, the vehicle's current route and location, incentives that may be offered by nearby fuel stations, etc. The vehicle system 910 may notify the driver about the selection of a fuel station and the vehicle 908 may be re-routed to the selected fuel station. Upon arriving at the selected fuel station, the driver may pull up to a fuel pump. The fuel pump may include a fuel pump system 965 configured to detect the RFID tags of vehicles, such as the vehicle identification tag 912 in order to obtain an identification of the vehicles. The fuel pump system 965 and the payment system 960 may be configured to communicate with each other. The fuel payment system 960 may send payment information to the fuel pump system 965. After the driver has completed re-fueling, the driver may simply drive away. The fuel pump system 965 may send the fuel merchant system 915 information about the identification of the vehicle 908, the amount of fuel purchased, and the payment information. The fuel merchant system 915 may use the information to complete a transaction with the driver for the purchase of the fuel. For example, the fuel merchant system 915 may communicate with the server 950 to charge the driver for the fuel according to the process 600 shown in FIG. 6A. Additionally, the fuel merchant system 915 may communicate with the server 950 in order to create a smart contract between the driver and the fuel merchant. The smart contract may be created and executed according to the process 601 shown in FIG. 6B.

### Augmented Reality (AR), Mixed Reality and Blockchain Based E-Commerce

AR or mixed reality enabled devices, such as wearable smart glasses, head mounted devices, holographic devices, or smartphone applications overlay digital content on top of a real world view, thus, enhancing a user's experience of the real world. The overlay content may be 3D models generated based on 3D scanning real world objects. AR enables users to experience online shopping in a virtual environment. For example, using AR, browse virtual stores and view 3D models of items for sale in virtual stores. Just as in the real world, customers may be able to handle and examine various physical details of the products. Blockchain smart contracts may be utilized to provide an e-commerce platform where customers may purchase items from online merchants with cryptocurrency and digital wallets. Information about a product, such as country of origin, materials, ingredients, price, description, measurements, terms and conditions, 3D model of the physical product, etc., may be hashed and recorded in a blockchain. This provides proof of ownership of virtual goods and products and enables accurate tracking of any changes made to this information. Artificial intelligence (AI) may be utilized for generating 3D models of products based on 2D images of the products. Smart contracts may be utilized to conduct transactions between merchants and customers.

As an example, a customer may shop for clothing by browsing different stores in a virtual shopping mall via a wearable AR device, such as a pair of smart glasses. The customer may examine a 3D model of a shirt as he or she would in the real world. Additionally, the customer may virtually try on the shirt using a 3D model of the customer's body. If the customer decides to purchase the shirt, the customer may initiate a transaction with the merchant of the store. A transaction may be submitted to the blockchain via the customer's digital wallet to transfer money (cryptocurrency) from the customer to the merchant. Various smart contracts may be utilized to implement various aspects of the e-commerce process. For example, based on detecting that the sale price of the shirt has been successfully transferred from the customer to the merchant, a smart contract may be executed to initiate shipment of the shirt from the merchant's warehouse to the customer. As described above with reference to supply chain monitoring and tracking, RFID tags and other IoT devices may be utilized to track the shipment of the shirt from the merchant's warehouse to the delivery of the shirt to the customer's residence.

### Quantum Computing

One of the concerns of quantum computing is that it may increase the probability of breaking cryptographic algorithms and thus, weaken overall security for the blockchain. This may be addressed by requiring larger key sizes for blockchain asymmetric-key pairs of cryptographic algorithms. In some cases, if there is a concern that a block may be decrypted in the future, a dynamically changing cryptographic hash may be utilized. A different cryptographic hash may be dynamically selected for a particular block or the entire blockchain based on various factors, such as whether there is a concern that the block will be decrypted in the future, increasing a strength of the hash, utilizing a hash that is better suited for protecting privacy. In some cases, different cryptographic hashes may be selected for different blocks.

### Anonymity and Privacy

As discussed above, the use of a private/public key pair to establish user authenticity during validation of a blockchain transaction provides some privacy as it does not reveal user identity. However, the transactions stored on a blockchain may be visible to the public. It has been shown that user identity may be derived from the publicly available transaction information.

### Blockchain Size

Depending on a frequency at which events are recorded in a blockchain, the size of the blockchain may grow quickly. Computing/storage capacity (i.e., faster processors, larger storage components) may be needed to support the expansion of the blockchain. In some cases, blocks may be compressed prior to being added to the chain. In some cases, blocks may be eliminated, for example, at the beginning of the blockchain, when they become stale or irrelevant. As an example, a method for “replacing” the first 1000 transactions with a new block that effectively mimics the hash of the 1000 transactions may be useful for managing blockchain size.

### Blockchain Immutability

In some cases, content in a blockchain may need to be deleted. For example, content may need to be deleted if there is a security breach or if the content is no longer relevant. A level of immutability of a blockchain may depend on a type of the blockchain. For example, changing content may be difficult in a public blockchain due to its possible impact on a large number of users. According to some techniques, data stored in a private blockchain, or a public blockchain controlled by a few entities may be changed by recording a flag (current block) where the change is being made, and adding the current block (referred to by the flag) to the blockchain. The added block may then indicate the change made to the previous block.

As another example, a blockchain may need to be changed to resolve a broken link. For example, the hash of a changed block may no longer match the hash stored in the block+1. In some cases, the blockchain may need to be changed in order to reverse the results of illegal transactions. In some cases, the blockchain may need to be changed to address software errors, erroneous transactions, or remove information that is confidential or required by law to be removed. If the blockchain is immutable, these errors and information may be permanently embedded in the blockchain. Additionally, the blockchain may need to be changed to comply with regulatory concerns, such as the European Union's incoming General Data Protection Regulation (GDPR), or California Consumer Privacy Act (CCPA), regarding consumer data privacy and ownership rights, US Fair Credit Reporting Act, and the SEC's “Regulation SP,” which require that recorded user identifiable personal financial data be redactable.

Some techniques may allow modifications to the blockchain to address software errors, legal and regulatory requirements, etc., by allowing designated authorities to edit, rewrite or remove previous blocks of information without breaking the blockchain. Such techniques may enable blockchain editing by using a variation of a “chameleon” hash function, through the use of secure private keys. This editing may allow smart contracts that were flawed at issue to be updated so that the changes carry over to subsequent smart contracts in the blockchain. Using these techniques, blocks that have been changed may be using a “scar” or mark that cannot be removed, even by trusted parties.

According to some techniques, when a block is hashed, any confidential information, such as personally identifiable information, and IP addresses, is not included in the hash because it is not part of the data values that were hashed. But because there is no hash of the confidential information, it may be changed. According to some techniques, the confidential information may not be placed or recorded into the blockchain. Rather the information may reside in a file that is external to the blockchain. A hash of that file, however, may be recorded in the blockchain. For example, a user's confidential information may be deleted locally without affecting the blockchain.

As another example, assuming that all content included in a block in a blockchain cannot be changed after a block is added to the blockchain, a determination may be made before adding data to the blockchain of whether some or all of that data may need to be deleted at a later time. For example, confidential information (i.e., data to be deleted at a later time) may be stored as a file that is external to the block and the blockchain. For the purposes of creating the block, a link to the file containing the confidential information and a hash of the file containing the confidential information file may be added to the block. An example of a link would be an HTTP link. During confirmation of the block that is to be added to the blockchain, the network nodes may be able to access the confidential information and verify that the confidential information based on the hash value of the file in the block. Because the hash value of the file is a part of the block, the file containing the confidential information may not be easily changed. However, it may be possible to change the confidential information file by changing the data therein and adding a nonce. This may seek to change the nonce until the resulting hash equals the hash that is stored in the blockchain. However, this would be difficult (probably near impossible), and an inspection of the modified confidential information file would reveal the added nonce, which may then raise suspicion that information was changed since it was first added to the blockchain.

Files containing confidential information may be encrypted (e.g., through an asymmetric key encryption function) prior to the hashing operation. When “deleting” the confidential information, the file containing the confidential information may be deleted or removed resulting in the link, which is stored in the blockchain, being ineffective for retrieving the file. The hash of the file, and the link, remain in the blockchain so that the linking of the blocks through hash functions is not affected. However, because of this change, a transaction that is part of the block or part of a different special block could be added to the blockchain to indicate that the link is no longer effective and the confidential information file is no longer part of the blockchain. This may effectively keep confidential information out of the blockchain while providing the confidential information to users of the blockchain and proof of authenticity of the confidential information before it is deleted from the blockchain. This may come with drawbacks because access to data implies that such data may be stored. Accordingly, those with access to the confidential information file, while it was part of the blockchain, may have stored that information in another location that may no longer be reachable during the “deleting” operation discussed above.

### 51% Attack

A “51% attack” refers to an individual mining node or a group of mining nodes controlling more than 50% of a blockchain network's mining power, also known as hash rate or hash power. The hash rate is a measure of the rate at which hashes are being computed on the blockchain network. As described above, hashing may include taking an input string of a given length, and running it through a cryptographic hash function in order to produce an output of a fixed length. A blockchain network's hash rate may be expressed in terms of 1 KH/s (kilohash per second) which is 1,000 bashes per second, 1 MH/s (megahash per second) which is 1,000,000 hashes per second, 1 TH/s (terahash per second) which is 1,000,000,000,000 hashes per second, or 1 PH/s (petahash per second) which is 1,000,000,000,000,000 hashes per second. As an example, a mining node in a blockchain utilizing a proof of work consensus model (PoW) may perform hashing in order to find a solution to a difficult mathematical problem. The hash rate of the mining node may depend on the computational resources available to that node. A mining node that successfully solves the mathematical problem may be able to add a block to the blockchain. Thus, by ensuring that invalid transactions cannot be included in a block, mining nodes increase the reliability of the network. Transactions may be deemed invalid if they attempt to spend more money than is currently owned or engage in double spending. If a mining node intentionally or unintentionally includes an invalid transaction in a block, then the block will not be validated by the network. Additionally, nodes that accept the invalid block as valid and proceed to add blocks on top of the invalid block will also end up wasting computational resources. Thus, mining nodes are discouraged from cheating by intentionally adding invalid transactions to blocks and accepting invalid blocks as valid.

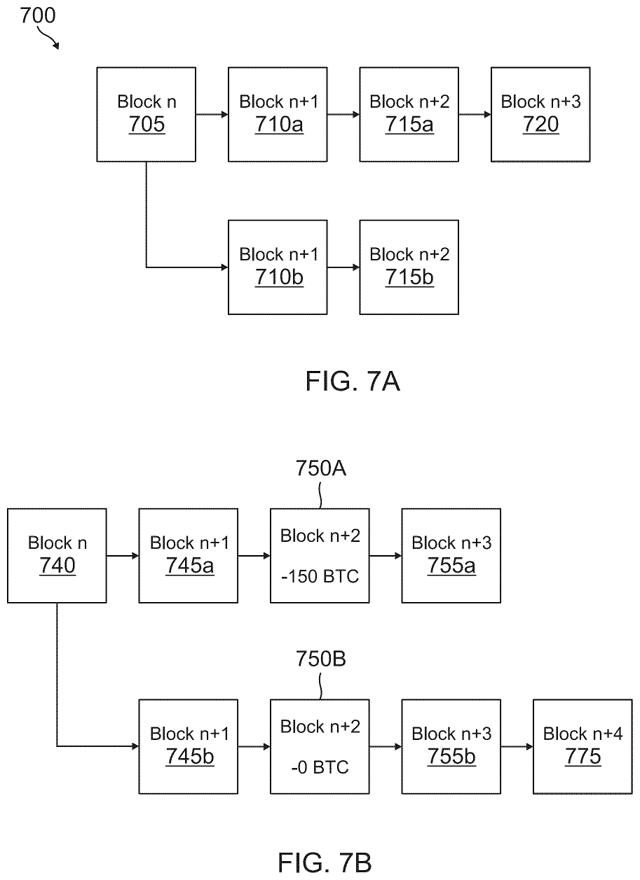

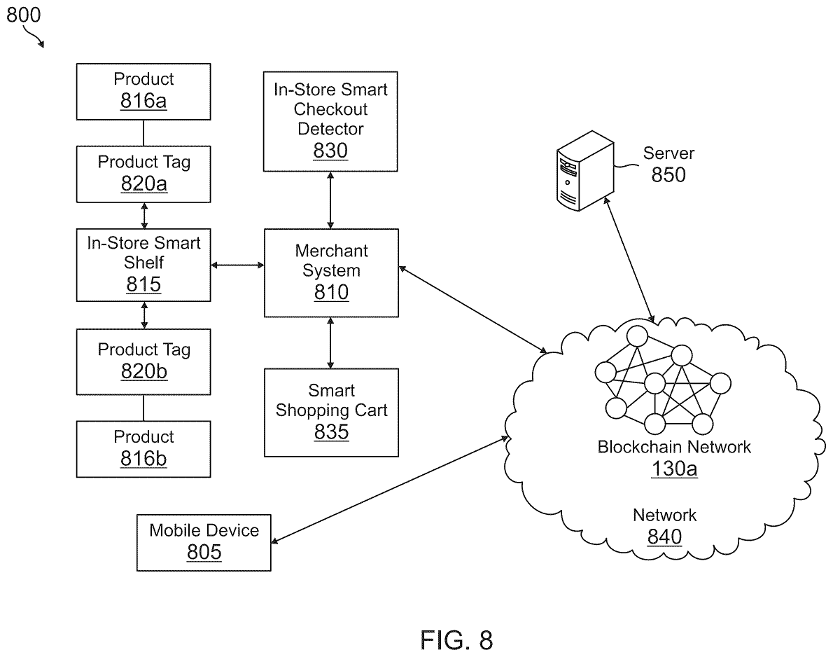

An entity may be able to disrupt the network by gaining control of 50% of a network's hash rate. In a 51% attack, a blockchain node may intentionally reverse or overwrite transactions and engage in double spending. When a node generates a valid block of transactions, it broadcasts the block to the network for validation. In some cases, a node controlling more than 50% of a network's hash rate may mine blocks in private without broadcasting them to the network. In such a scenario, the rest of the network may follow a public version of the blockchain while the controlling node may be following its private version of the blockchain. FIG. 7A shows a fraudulent and valid version of a blockchain 700. The valid blockchain on the top comprises the valid blocks 705, 710a, 715a, and 720. The fraudulent blockchain on the bottom is not broadcast to the network and includes the blocks 705, 710b, 715b, and an invalid block 720.

FIG. 7B shows another fraudulent and valid version of a blockchain. The valid version of the blockchain includes nodes 740, 745a, 750a, and 755a. The fraudulent version of the blockchain includes nodes 740, 745b, 750b, 755b, and 775. However, following the longest chain rule, the network may select and utilize the private or fraudulent blockchain comprising nodes 740, 745b, 750b, 755b and 775. Since it is the longest chain, previous transactions may be updated according to this chain. The cheating node may include transactions that spend money, such as the block 750b including the transaction for 150 BTC, on the public or fraudulent version of the blockchain without including these transactions in the private version of the blockchain. Thus, in the private version of the blockchain, the cheating node may continue to own the spent 150 BTC. When the cheating node controls more than 50% of the hashing resources of the network, it may be able to broadcast its private version of the blockchain and continue to create blocks on the private blockchain faster than the rest of the network, thus, resulting in a longer blockchain. Since there are two versions of the blockchain, the network may select the longest or fraudulent private blockchain as the valid blockchain. As a result, the rest of the network may be forced to use the longer blockchain. The public or valid version of the blockchain may then be discarded or abandoned and all transactions in this blockchain that are not also in the private or fraudulent version of the blockchain may be reversed. The controlling or cheating node may continue to own the spent money because the spending transactions are not included on the fraudulent version of the blockchain, and the cheating node may therefore, spend that money in future transactions.

Because of the financial resources needed to obtain more hashing power than the rest of the entire network combined, a successful 51% attack may generally be challenging to achieve. However, it would be less expensive to achieve a 51% attack on a network with a lower hash rate than one with a higher hash rate. Additionally, the probability of a successful 51% attack increases with the use of mining pools in which multiple nodes may combine their computational resources, for example, when mining is performed from the same mining pool.

### Description of Exemplary Embodiments

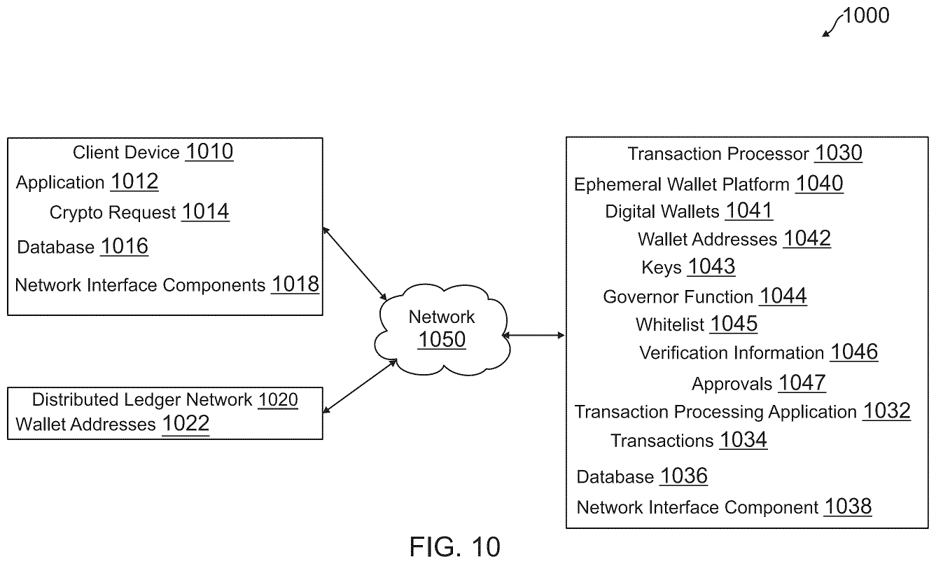

FIG. 10 is a block diagram of a networked system 1000 suitable for implementing the processes described herein, according to an embodiment. As shown, system 1000 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 10 may be deployed in other ways, and that the operations performed, and/or the services provided by such devices and/or servers, may be combined or separated for a given embodiment and may be performed by a greater number or fewer number of devices and/or servers. One or more devices and/or servers may be operated and/or maintained by the same or different entities.

System 1000 includes a client device 1010, a distributed ledger network 1020 for wallet addresses 1022, and a transaction processor 1030 in communication over a network 1050. Client device 1010 may be used to request processing of cryptocurrency transactions, such as through a payment platform, application, and/or application extension of transaction processor 1030, which may be facilitated through digital accounts and wallets that allow for use of cryptocurrency to process transactions using transaction processor 1030. During cryptocurrency transaction processing, wallet addresses 1022 may be associated with senders or recipients of cryptocurrency for cryptocurrency transaction processing, which may correspond to endpoint identifiers on a blockchain for a digital wallet where cryptocurrency may be sent to and from for cryptocurrency transaction processing. Transaction processor 1030 may facilitate transaction processing by providing an ephemeral wallet platform 1040 to control wallet usage and cryptocurrency transaction processing with wallet addresses 1022 on a blockchain.

Client device 1010, distributed ledger network 1020, and transaction processor 1030 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 1000, and/or accessible over network 1050.

Client device 1010 may be implemented using any appropriate hardware and software configured for wired and/or wireless communication with wallet addresses 1022 and/or transaction processor 1030 for processing payments and transactions using cryptocurrency and the like. Client device 1010 may correspond to an individual user, entity, or the like that utilizes a payment network and platform provided by transaction processor 1030 to process those transactions. In various embodiments, client device 1010 may be implemented as a personal computer (PC), a smart phone, laptop/tablet computer, wristwatch with appropriate computer hardware resources, other type of wearable computing device, and/or other types of computing devices capable of transmitting and/or receiving data. Although only one computing device is shown, a plurality of computing devices may function similarly.

Client device 1010 of FIG. 10 contains an application 1012, a database 1016, and a network interface component 1018. Application 1012 may correspond to executable processes, procedures, and/or applications with associated hardware. In other embodiments, client device 1010 may include additional or different software as required.

Application 1012 may correspond to one or more processes to execute modules and associated devices of client device 1010 to provide a convenient interface to permit a user of client device 1010 to enter, view, and/or process transactions including cryptocurrency transactions, such as by using a digital wallet of digital wallets 1041 having available cryptocurrency. In this regard, application 1012 may correspond to specialized hardware and/or software utilized by client device 1010 that may provide transaction processing using an amount of a cryptocurrency, where the cryptocurrency may be sent to, or requested from, a digital wallet and wallet address controlled and managed by ephemeral wallet platform 1040 on transaction processor 1030. As such, application 1012 may be used to generate and/or send a cryptocurrency or crypto request 1014 for a withdrawal or deposit of the amount of the cryptocurrency to the digital wallet managed by ephemeral wallet platform 1040. This may be done using an authorized address of wallet addresses 1022 that is allowed to send or receive cryptocurrency with the digital wallet and wallet address used by ephemeral wallet platform 1040, or by providing, verifying, and/or other authentication processes or information, such as verification information for a user, entity, or transaction. In this regard, crypto request 1014 may include verification information and/or provide verification information for the withdrawal or deposit of cryptocurrency, which may include a payment code, a user identity of a user or entity identity of an entity, authentication information, a destination wallet address of one or more of wallet addresses 1022, or the like.

In some embodiments, the transaction requested by crypto request 1014 may correspond to a withdrawal, such as a request for a payment to be made to the user or entity using client device 1014 using the digital wallet managed by ephemeral wallet platform 1040. As such, crypto request 1014 may provide sufficient information to verify the outgoing payment and withdrawal, which may require verifying verification information for the user/entity, providing a payment code or other alphanumeric code allowing for release or withdrawal of the funds, and the like. Crypto request 1014 may identify the corresponding wallet address of wallet addresses 1022 to receive the cryptocurrency. However, where crypto request 1014 corresponds to a deposit to the digital wallet managed by ephemeral wallet platform 1040, crypto request 1014 may provide an instruction to the device, server, or platform managing the digital wallet to have cryptocurrency sent from one of wallet addresses 1022 to the digital wallet and wallet address managed by ephemeral wallet platform 1040. Exchange, conversion, and/or sale of cryptocurrency and electronic transaction processing in a cryptocurrency may be done through a user interface enabling the user to enter and/or view an amount of funds to be paid in a cryptocurrency (e.g., request a payment to the merchant), the requested cryptocurrency for the payment, and other conditions for processing cryptocurrency transaction. Payments and transactions of cryptocurrency may be performed by exchanging cryptocurrency keys between digital wallets using wallet addresses 1022, as described herein. Application 1012 may also be used to receive a receipt or other information based on transaction processing.

In various embodiments, application 1012 may correspond to a general browser application configured to retrieve, present, and communicate information over the Internet (e.g., utilize resources on the World Wide Web) or a private network. For example, application 1012 may provide a web browser, which may send and receive information over network 1050, including retrieving website information, presenting the website information to the user, and/or communicating information to the website, including payment information for the transaction. However, in other embodiments, application 1012 may include a dedicated application of transaction processor 1030 or other entity (e.g., a merchant), which may be configured to assist in processing transactions, such as a mobile application on a mobile device.

Client device 1010 may further include database 1016 which may include, for example, identifiers such as operating system registry entries, cookies associated with application 1012 and/or other applications, identifiers associated with hardware of client device 1010, or other appropriate identifiers. Identifiers in database 1016 may be used by a payment/service provider to associate client device 1010 with a particular account maintained by the payment/service provider. Database 1016 may also further store received transaction data and/or data for transactions using cryptocurrency, including private keys, crypto redemption or payment codes, offers and/or extensions of access to the cryptocurrency, and repayment terms of the accessed amount.

Client device 1010 includes at least one network interface component 1018 adapted to communicate with wallet addresses 1022, transaction processor 1030, and/or other devices or servers over network 1050. In various embodiments, network interface component 1018 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Wallet addresses 1022 on a blockchain managed and/or provided through distributed ledger network 1020 may be maintained, for example, by users, entities, or the like, which may be associated with a digital wallet or other blockchain digital account for sending and receiving cryptocurrencies (e.g., in different currencies or blockchains, such as Bitcoin, Ethereum, etc.). As such, distributed ledger network 1020 may correspond to multiple different devices, servers, or other processing nodes that may maintain the digital ledger for the blockchain, verify transactions, write and verify blocks, and the like, which may include providing wallet addresses 1022 for cryptocurrency transactions. Wallet addresses 1022 may correspond to one or more cryptocurrencies and blockchains, and may include a string of letters, numbers, or other characters uniquely identifying an address, endpoint, or the like on a network and blockchain. Wallet addresses may be generated from public cryptographic keys and may be used to send and receive private cryptographic keys for cryptocurrency. Wallet addresses 1022 may therefore reside on and/or be affiliated with a blockchain and cryptocurrency such that the address allows for transfer of cryptocurrency to and from a digital wallet that stores the corresponding private cryptographic keys for the cryptocurrency that verifies ownership of the cryptocurrency (e.g., allows for signing of digital transactions and therefore transfer and possession of the cryptocurrency).

Wallet addresses 1022 may be managed by a computing device and/or application, which may be accessible over the Internet (e.g., network 1050) and provide for interfacing with digital wallets and wallet applications corresponding to wallet addresses 1022. In this regard, wallet addresses 1022 may be associated with a digital wallet that may correspond to an online or offline storage component of the private cryptographic keys for cryptocurrency. Wallet addresses 1022 may also be associated with a network interface component adapted to allow communication with client device 1010, transaction processor 1030, and/or other devices or servers over network 1050 for exchange of private cryptographic keys during cryptocurrency transaction processing.

Transaction processor 1030 may be maintained, for example, by an online service provider, which may provide operations for processing cryptocurrency transactions through digital wallets including ephemeral wallets and addresses provided through a digital platform and governor function. In such embodiments, transaction processor 1030 may provide a digital platform to interface with and/or utilize wallet addresses 1022 to effectuate cryptocurrency transactions, which may include providing a governor function for controlling incoming and outgoing cryptocurrency transactions to and from one or more of wallet addresses 1022. Transaction processor 1030 includes one or more processing applications which may be configured to interact with client device 1010 and/or wallet addresses 1022 for cryptocurrency transactions and payments. In one example, transaction processor 1030 may be provided by PAYPAL®, Inc. of San Jose, CA, USA. However, in other embodiments, transaction processor 1030 may be maintained by or include another type of service provider.

Transaction processor 1030 of FIG. 10 includes an ephemeral wallet platform 1040, a transaction processing application 1032, a database 1036, and a network interface component 1038. Ephemeral wallet platform 1040 and/or transaction processing application 1032 may correspond to executable processes, procedures, and/or applications with associated hardware. In other embodiments, transaction processor 1030 may include additional or different modules having specialized hardware and/or software as required.

Ephemeral wallet platform 1040 may correspond to one or more processes to execute software using associated hardware components of transaction processor 1030 to offer and/or transfer cryptocurrency between different digital wallets using digital wallets 1041 and wallet addresses 1022, which may be based on ephemeral wallet tools and processes to enforce constraints and limits on cryptocurrency transactions. In some embodiments, ephemeral wallet platform 1040 may manage cryptocurrency transactions for a cryptocurrency exchange, sale, and/or purchase platform where users may utilize cold (e.g., offline) and/or hot (e.g., online) digital wallets to engage in cryptocurrency exchanges with ephemeral wallet platform 1040 and/or other users and entities, as well as perform electronic transaction processing using cryptocurrency. Ephemeral wallet platform 1040 may receive transaction requests, such as crypto request 1014, and verify the requests based on verification data with the requests. If authorized, cryptocurrency may be deposited in or withdrawn from one or more of digital wallets 1041.

For example, transaction processor 1030, as well as client device 1010 and/or wallet addresses 1022, may be associated with blockchains and/or cryptocurrency payment networks, which may be used to establish and process cryptocurrency transactions for different cryptocurrencies. For example, distributed transaction and/or network participants for cryptocurrencies may correspond to networks of devices that may communicate to share, update, and maintain a distributed ledger for a blockchain and cryptocurrency. In this regard, the distributed network participants may include transaction participants and miners, where transaction participants may process transactions and record those transactions and exchanges of cryptocurrencies and/or virtual currencies using a blockchain. A record may be required to be generated, updated, and maintained on a blockchain. Digital wallets 1041 may correspond to hot or cold storage components for cryptocurrency, and therefore may each have one or more of wallet addresses 1042 for digital wallets 1041, which may be used to transfer cryptocurrency to and/or from the storage component (e.g., by designating an address on a network where privacy cryptographic keys for cryptocurrency values and/or assets may be sent to and/or from for cryptocurrency transactions. In this regard, wallet addresses 1042 may similarly reside on a blockchain and blockchain network in a similar manner to wallet addresses 1022 for other digital wallets accessible over network 1050, and therefore may have the same or similar functionalities.

Digital wallets 1041 further include keys 1043, such as private cryptographic keys of cryptocurrency and/or cryptocurrency values, which may be used to sign transactions and digital records and therefore convey possession and ownership of the cryptocurrency. Keys 1043 may correspond to the amount of value of the cryptocurrency held by digital wallets 1041 through possession of the private cryptographic keys in digital wallets 1041. The cryptocurrency for a user or entity may correspond to those assets owned or controlled by the user. This may include cryptocurrency assets for each user, which may correspond to cryptocurrency available in a cold digital wallet, online account or digital wallet for a user, and/or with a cryptocurrency exchange platform. To control use of digital wallets 1041 and keys 1043 with wallet addresses 1042, a governor function 1044 may be implemented to assess cryptocurrency transactions according to a whitelist 1045.

As such, governor function 1044 may be implemented with whitelist 1045 and/or receive whitelist 1045 for enforcement with one or more of digital wallets 1041 when executed and/or deployed. Whitelist 1045 may correspond to a list of approved, authenticated, or verified wallet addresses, users, devices, or other identifiers that may deposit or withdraw cryptocurrency with one or more of digital wallets 1041. In some embodiments, a payment code, authentication data, or other secret may be required for cryptocurrency deposits or withdrawals, which may be set with whitelist 1045 and required to be provided for governor function 1044 to approve a cryptocurrency transaction. Whitelist 1045 may also have other parameters to restrict cryptocurrency transactions for deposits or withdrawals, such as a length of time of enforcement, a purpose or reason for the cryptocurrency transaction, an amount of the cryptocurrency transaction, and/or a corresponding scenario or class of users/entities, such as group members or a settlement class for a lawsuit and/or lawsuit settlement.

Whitelist 1045 may be established through direct input of the wallet addresses, members, identifiers, or the like of the allowed and/or authorized senders/recipients of cryptocurrency transfers (e.g., payors/payees of cryptocurrency transactions). However, in other embodiments, whitelist 1045 may be generated programmatically by an entity uploaded and/or providing a set of data for the wallet identifiers, users, or the like, which may be parsed by ephemeral wallet platform 1040 and used to create whitelist 1045. Further, where payment codes may be used for users to redeem values of cryptocurrency from digital wallets 1041, such payment codes may be generated automatically and added to whitelist 1045. Whitelist 1045 may correspond to a programmatic enforcement mechanism, such as a callable API having a repository, data table, or the like with the allowed identifiers, codes, or the like. However, in other embodiments, a smart contract may be generated and persisted to a blockchain with whitelist 1045 in a distributed ledger record, which may be updated and new records verified on the blockchain as cryptocurrency transactions are processed.

Ephemeral wallet platform 1040 may receive crypto requests for transactions, such as crypto request 1014 for a transaction from client device 1010 and using one of wallet addresses 1022. Governor function 1044 may use whitelist 1045 with verification information 1046 for crypto requests to verify and/or validate whether the request is valid and authorized. As such, verification information 1046 may include wallet addresses 1022 for verification with whitelist 1045, payment codes, authentication or identity information for user identification, and the like. In some embodiments, verification information 1046 may further include cryptocurrency transaction parameters, such as location, items, price, tax, tip, merchant and/or user location or IP address, and the like for verification of a reason of the transaction. The requests may correspond to a deposit or a withdrawal, which may designate an amount (e.g., a transaction total or cryptocurrency value/amount) in a cryptocurrency and on a specified blockchain and network for cryptocurrency transaction processing and/or blockchain recordation. In some embodiments, cryptocurrency transactions may not designate the cryptocurrency wallet and/or wallet address, and instead may provide available cryptocurrency to transaction processing application 1032 for handling with transactions 1034 for cryptocurrency deposits and withdrawals, such as by designating a user or account, which may allow lookup of a corresponding wallet address.

Based on whether verification information 1046 can be verified, and therefore crypto requests for cryptocurrency transactions approved, approvals 1047 may be generated by governor function 1044 for cryptocurrency transfer and corresponding deposits or withdrawals of cryptocurrency from digital wallets 1041. In this regard, if one of approvals 1047 for a crypto withdrawal transaction is generated and authorized, one or more of keys 1043 for the corresponding cryptocurrency value may be withdrawn from a corresponding one of digital wallets 1041 and then transferred or paid to a digital wallet designated by one of wallet addresses 1022. As such, private cryptographic keys may be exchanged for the amount of cryptocurrency. This may be done by identifying those ones of keys 1043 to be transferred for the designated amount and establishing a private and/or secure communication channel (e.g., Secure Sockets Layer (SSL)) for transferring the keys. The secure communication channel may be established between corresponding ones of wallet addresses 1022 and wallet addresses 1042. The ones of keys 1043 identified may then be exchanged via the secure communication channel, and a corresponding record identifying the exchange of the private key, and therefore the ownership of the cryptocurrency asset and capability for signing transactions. As such, the secure communication channel may allow for keys 1043 to be securely exchanged to pay out or allow withdrawal of cryptocurrency by governor function 1044 and from digital wallets 1041. If approvals 1047 authorize the withdrawal and/or payments, then keys 1043 may be sent; otherwise, the withdrawal and/or payment may be refused and keys 1043 may not be transferred and/or exchanged.

In a similar manner for cryptocurrency deposits, approvals 1047 may allow for depositing of cryptocurrency, but only by authorized wallet addresses, users, or other identifications and/or verifications denoted by whitelist 1045. With cryptocurrency deposits, verification information 1046 may verify that the sender of cryptocurrency is authorized and not mistaken or otherwise unapproved to deposit cryptocurrency (e.g., to limited unintentionally or erroneous deposits for defunct or old wallets and/or entities controlling the wallets). Approvals 1047 may also verify deposits based on other parameters of verification information 1046, which may include a length of time or time period that deposits are authorized, an amount (e.g., maximum or minimum) for deposits, and/or a reason or purpose for the deposit. If authorized, a secure communication channel may be established between the corresponding ones of wallet addresses 1022 and wallet addresses 1042 may be established and ephemeral wallet platform 1040 may receive the private cryptographic keys for the cryptocurrency, which may be added to and/or stored by digital wallets 1041. However, if a deposit is not approved by approvals 1046, then the private cryptographic keys for the deposit may be refused and/or the secure channel not established to allow transfer and/or exchange of the keys. This may include preventing or declining receipt of the keys. However, if the keys are sent from one or more of wallet addresses 1022 without receiving one or more of approvals 1047, then a process may be implemented to initiate another cryptocurrency transaction and create/update a record or block on a the blockchain to effectuate a further cryptocurrency transaction and transfer that returns the private keys to the sender digital wallet and wallet address. Ephemeral wallet platform 1040 may exchange keys 1043 corresponding to via available cryptocurrency and/or unspent transaction outputs (UTXOs) resulting from cryptocurrency transactions (e.g., when there are transaction outputs from processing a cryptocurrency transaction that are unspent or unused). A risk engine may run a risk analysis for a user using a rule-based and/or ML model-based engine and system that may score user activities, crypto transaction parameters, and/or other data and compare that score to a threshold prior to generating and/or authorizing approvals 1046.

Transaction processing application 1032 may correspond to one or more processes to execute software using associated hardware components of transaction processor 1030 to process a transaction and/or exchange of an amount of funds including payments using cryptocurrency. In some embodiments, transaction processing application 1032 may be used by a user associated with client device 1010 to establish a payment account and/or digital wallet, which may be used to process transactions and/or buy/sell/transfer cryptocurrency. In various embodiments, an amount of funds in one or more currencies may be established for the account including cryptocurrency. A digital token for the wallet may be used to send and process payments, for example, through an interface provided by transaction processor 1030. The digital wallet may be accessed and/or used through a browser application/extension and/or dedicated payment application executed by client device 1010 and engage in electronic transaction processing, such as using cryptocurrency and/or through an amount of currency obtained from a purchase/sale of cryptocurrency. In various embodiments, transaction processing application 1032 may be used to access digital wallets 1041 for use in processing transactions. In this regard, client device 1010 may establish one or more of transactions, which may be performed online or at physical merchant locations. In other embodiments, one or more transactions may correspond to checkout or payment requests where an amount of funds is to be paid to a seller, merchant, or other entity by a buyer, consumer, or similar entity.

In this regard, transaction processing application 1032 may interface with ephemeral wallet platform 1040 when processing transactions 1034, which may require approvals 1046 by governor function 1044 to control deposits and withdrawals of cryptocurrency. When performing transaction processing, transaction processing application 1032 may be required to obtain an approval via governor function 1044 prior to transfer or exchange of keys 1043 with digital wallets 1041, as well as deposits of further keys to digital wallets 1041. If approved, transactions 1034 may be processed, which may include paying out cryptocurrency from digital wallets 1041, as well as depositing additional cryptocurrency. Transaction processing application 1032 may be used to record and provide a transaction history for transactions 1034 and the like, such as a receipt, as well as update a distributed ledger and one or more blocks or records on a blockchain.

Additionally, transaction processor 1030 includes database 1036. Database 1036 may store various identifiers associated with digital wallets and wallet addresses, as well as account data, including payment instruments, financial information, account balances, authentication credentials, transaction processing histories and data for processed transactions, and the like. Although database 1036 is shown as residing on transaction processor 1030 as a database, in other embodiments, other types of data storage and components may be used including cloud computing storage nodes, remote data stores and database systems, distributed database systems over network 1050 and/or of a computing system associated with transaction processor 1030, and the like.

In various embodiments, transaction processor 1030 includes at least one network interface component 1038 adapted to communicate with client device 1010, wallet addresses 1022, and/or another device/server for a merchant over network 1050. In various embodiments, network interface component 1038 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 1050 may be implemented as a single network or a combination of multiple networks. For example, in various embodiments, network 1050 may include the Internet or one or more intranets, landline networks, wireless networks, and/or other appropriate types of networks. Thus, network 1050 may correspond to small scale communication networks, such as a private or local area network, or a larger scale network, such as a wide area network or the Internet, accessible by the various components of system 1000.

Although various components of system 1000 are described separately, functionality of the various components may be combined and/or performed by a single component and/or multiple computing devices in communication without departing from the invention.

FIG. 11 illustrates an exemplary diagram 1100 of an ephemeral digital wallet interacting with other digital wallets for cryptocurrency transactions that may be managed by a digital platform enforcing a whitelist for authorized cryptocurrency key exchanges through a governor function, according to an embodiment. Diagram 1100 represents an interaction of one of digital wallets 1041 managed by ephemeral wallet platform 1040 with one or more other digital wallets including different ones of digital wallets 1041 and/or external wallets corresponding to wallet addresses 1022. The processes performed to manage an ephemeral wallet 1102 shown in diagram 1100 may be performed by ephemeral wallet platform 1040 of transaction processor 1030 in system 1000 of FIG. 10.

In diagram 1100, ephemeral wallet platform 1040 is used to setup, fund, and utilize ephemeral wallet 1102 for limited cryptocurrency transactions and key exchanges, such as limiting ephemeral wallet 1102 to only authorized cryptocurrency key exchanges based on a whitelist established with governor function 1044. In order to setup ephemeral wallet 1102 and fund the wallet with initial cryptocurrency, a custodial wallet 1104 may be used. Custodial wallet 1104 may be managed by transaction processor 1030 and/or another entity, such as a third-party cryptocurrency lender, trader, brokerage or digital trading platform, or the like. As such, custodial wallet 1104 may correspond to one of digital wallets 1041 when funding by transaction processor 1030 or a customer of transaction processor 1030 that utilizes a wallet on a platform of transaction processor 1030 but could also be external wallets connectable to transaction processor 1030 to exchange cryptocurrency through wallet addresses 1022. Ephemeral wallet 1102 may have an on-chain wallet address for a corresponding blockchain for which ephemeral wallet is capable of receiving cryptocurrency keys (e.g., private cryptographic keys for transaction and ledger signing), as well as stored and distributing/transferring/paying out those keys.

In this regard, funding of ephemeral wallet 1102 may require certain safeguards, authorizations, and verification information to allow for deposits, thereby preventing other parties from accidentally depositing cryptocurrency without knowledge that ephemeral wallet 1102 is of limited use and/or for a correct wallet address. As such, governor function 1044 may receive and/or setup a whitelist of approved depositors that may provide cryptocurrency and corresponding cryptographic private keys to ephemeral wallet 1102 for storage. The whitelist may be generated by governor function 1044 and/or another process of ephemeral wallet platform 1040 based on provided data for authorized depositors, funders, or custodians of ephemeral wallet 1102 that manage ephemeral wallet 1102 and/or utilize ephemeral wallet 1102 for a specific purpose. As such, the whitelist may designate custodial wallet 1104 that is allowed to deposit cryptocurrency to ephemeral wallet 1102, which may allow the public to view ledger transactions and deposits to ephemeral wallet 1102. Governor function 1044 may therefore allow incoming deposits and cryptocurrency transactions to ephemeral wallet 1102, such that when the transaction is received at a digital wallet address for ephemeral wallet 1102, the keys may be accepted and the transaction allowed. However, if another wallet address attempts to send keys and deposit cryptocurrency, governor function 1044 may decline the transaction, return the keys through another cryptocurrency transaction (which may be viewable on the public ledger), and/or prevent the transaction from proceeding and the keys being transferred.

Once funded, ephemeral wallet 1102 may be used for specific purposes and/or payments for cryptocurrency transactions and transfers, which may be managed and controlled by governor function 1044. For example, an end user claims database 1106 may designate a set of claims that users may make for portions of the cryptocurrency to be paid to the user, such as for a specific purpose. The purpose may be time and/or purpose based, such as a settlement agreement and/or settlement/judgment payment, which may allow for users to make claims to their corresponding authorized portions of the cryptocurrency based on the claims in end user claims database 1106. Further, an end user identity database 1108 may be used to verify user, digital wallet, and/or other information in response to a request for a claim in end user claims database 1106. As such, verification information may be required with a request for a cryptocurrency transaction and/or claim from end user claims database 1106, and may be verified against end user claims database 1106.

The whitelist may include and/or be verified using end user claims database 1106 and end user identity database 1108. When a user makes a claim, the user may provide an end user claims wallet 1110, which may be designated by one of wallet addresses 1022. A digital wallet address for end user claims wallet 1110 and/or further verification information for the user making the claim may be provided, which may be verified by governor function 1044 using the whitelist, end user claims database 1106, and/or end user identity database 1108. If approved, governor function 1044 may allow a transaction to be processed from ephemeral wallet 1102 with end user claims wallet 1110, such as a payment and transfer of keys to end user claims wallet 1110. However, if not, governor function 1044 may prevent or decline the transaction.

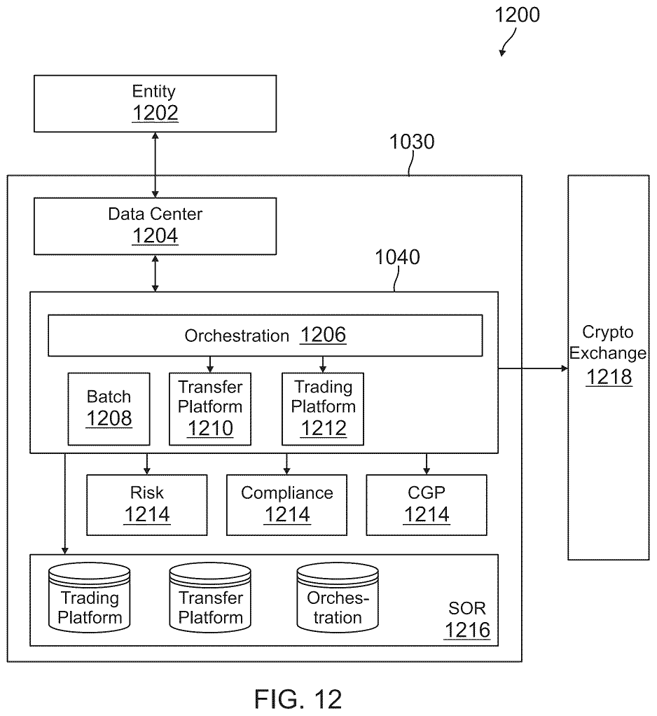

FIG. 12 illustrates an exemplary system environment 1200 where a digital platform may provide an ephemeral digital wallet service for cryptocurrency transactions with a digital wallet address, according to an embodiment. System environment 1200 represents a platform and environment of transaction processor 1030 where an ephemeral digital wallet and wallet address may be managed by ephemeral wallet platform 1040 for authorized cryptocurrency key exchanges, such as deposits, withdrawals, payments, and transfers of cryptocurrency between different digital wallets by their wallet addresses. The processes performed to manage ephemeral wallet 1102 from diagram 1100 may be performed by ephemeral wallet platform 1040 of transaction processor 1030 using the components shown in system environment 1200.

In system environment 1200, an entity 1202 interacts with transaction processor 1030 to establish an ephemeral digital wallet for a specific purpose and/or a set length of time for activity, validity, or the like. In this regard, entity 1202 may correspond to a business, company, trading platform, or the like, but may also correspond to individual users or groups of users that may utilize ephemeral wallet services provided by ephemeral wallet platform 1040. Entity 1202 may provide, upload, and/or transmit data to a data center 1204 of transaction processor 1030, which may correspond to data records for allowable cryptocurrency key transfers and/or transactions, such as those digital wallets that are allowed to deposit cryptocurrency (e.g., transfer keys into the ephemeral wallet) and those designated payees or conditions for payment/withdrawal of cryptocurrency. Data center 1204 may interact with an orchestration platform 1206 that may orchestrate operations for ephemeral wallet establishment and usage, such as using an orchestration layer between different services and components for cryptocurrency transfer, trading, and the like.

Orchestration platform 1206 may include a batch processor 1208, a transfer platform 1210, and a trading platform 1212. Orchestration platform 1206 may further interact with security services 1214, such as a risk, compliance, and/or CGP service that may provide for risk, fraud, compliance, and other checks on cryptocurrency transactions and uses of the ephemeral wallet. Batch processor 1208 may be used to create a whitelist for the ephemeral wallet, which may correspond to the allowed depositors, payees, and/or withdrawal/payment conditions provided by entity 1202 to data center 1204. In this regard, a system of records (SOR) 1216, which may retain databases and/or data records for orchestration platform 1206, may store the whitelist and may provide the whitelist during runtime of orchestration platform 1206.

Once the whitelist has been created and stored by SOR 1216, orchestration platform 1206 may determine a digital wallet address to be utilized for the ephemeral digital wallet, and may designate a storage platform, such as SOR 1216 or other hot or cold storage component, for storage of the cryptographic keys for the cryptocurrency. This may create the ephemeral digital wallet. However, to implement limitations and restrictions on the ephemeral wallet, such as for limited cryptocurrency transactions and/or a limited amount of time, orchestration platform 1206 may further implement and/or utilize a governor function, such as governor function 1044, for the ephemeral digital wallet and wallet address. The governor function may allow and restrict certain uses of the ephemeral digital wallet with transfer platform 1210 and/or trading platform 1212, such as to limit and/or prevent deposits of cryptocurrency and/or payments/withdrawals of cryptocurrency. In this regard, a cryptocurrency or crypto exchange 1218 may request cryptocurrency transactions with the ephemeral wallet via transfer platform 1210 and/or trading platform 1212, where the governor function 1044 may utilize the whitelist from SOR 1216 to limit those transactions to only approved and authorized transactions by entity 1202.

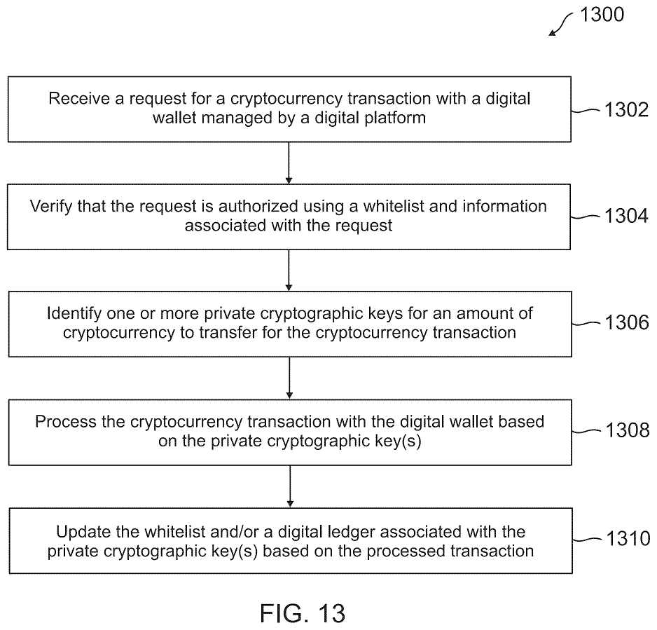

FIG. 13 illustrates a flowchart 1300 for a digital platform for ephemeral cryptocurrency addresses for digital wallets and authorized cryptocurrency key exchanges, according to an embodiment. For example, flowchart 1300 may be performed by ephemeral wallet platform 1040 using digital wallets 1041 with governor function 1044. In this regard, ephemeral wallet platform 1040 may receive crypto request 1014 from application 1012 to transfer cryptocurrency to or from wallet addresses 1022 and wallet address 1042 for digital wallets 1041. In other embodiments, the request need not be received from client device 110, but instead be received by another wallet address and/or internal endpoint, including the service provider, such as based on distributions of cryptocurrency or other rules and/or setups for cryptocurrency transactions. Note that one or more steps, processes, and methods described herein of flowchart 1300 may be omitted, performed in a different sequence, or combined as desired or appropriate.

At step 1302 of flowchart 1300, a request for a cryptocurrency transaction with a digital wallet managed by a digital platform is received. Crypto request 1014 may correspond to a request to deposit or withdraw cryptocurrency from digital wallets 1041 with one or more of wallet addresses 1022. Furthermore, the request may be initiated based on a number of factors such as a cryptocurrency being distributed according to an agreement, payment fund, distribution, or the like, such as a settlement agreement or judgment for distribution of cryptocurrency for a settlement class or other group of users. However, on receipt of crypto request 1014, it may be determined that the digital wallet and/or wallet address of digital wallets 1041 and/or wallet addresses 1042, respectively, is controlled and/or managed by governor function 1044 so that the digital wallet and address may function in an ephemeral manner, thereby being available for usage for a limited scope and time. Thus, a verification and authorization may be required prior to processing crypto request 1014.

At step 1304, it is verified that the request is authorized using a whitelist and information associated with the request. Crypto request 1014 may be receive with verification information 1046, or verification information 1046 may be determined and/or inferred from crypto request 1014 and/or additional information provided with crypto request 1014, such that governor function 1044 may verify and authorize crypto request 1014. This may be done based on one or more of wallet addresses 1022 designated by crypto request 1014, as well as a payment code, user and/or account identification, or the like that may be used to authorize withdrawal and/or payment of cryptocurrency. In some embodiments, crypto request 1014 may correspond to a deposit transaction, and verification may be required to ensure that the party depositing the transaction is the correct party, authorized, and not accidentally depositing cryptocurrency in the wrong digital wallet. In some embodiments of an ephemeral digital wallet, all deposits may be barred or unauthorized, or any deposit after an initial funding deposit from another wallet (e.g., where the ephemeral wallet may be used as a payout mechanism for a settlement or the like).

To verify and authorize crypto request 1014, whitelist 1045 may be used with verification information 1046 to generate approvals 1047, where whitelist 1045 may include authorized digital addresses, users/accounts, payment codes, reasons or purposes for withdrawal/transfers, allowable time periods and the like. As such, whitelist 1045 may be references to authorize crypto request 1014 through a lookup and/or comparison of such data. Cryptocurrency available to the user and/or entity may be determined using one of digital wallets 1041, which may include keys 1043 to withdraw and/or pay. The available cryptocurrencies and/or balances for the cryptocurrencies may be identified based on crypto request 1014, and sufficient balance may be required to authorize the transaction using the cryptocurrency, as well as any other balance of other virtual currencies (e.g., NFTs) and the like. In one or more embodiments, the digital wallet may have different values and/or portions of cryptocurrencies, such as by UTXOs, which may be used for transaction processing.

At step 1306, one or more private cryptographic keys for an amount of cryptocurrency to transfer for the cryptocurrency transaction is/are identified. Crypto request 1014 may specify an amount of cryptocurrency and/or a value to be withdrawn from one of digital wallets 1041, and governor function 1044, after determining one of approvals 1047 for crypto request 1014, may identify one or more of keys 1043 that may meet that amount and/or be specified in the request. One or more of keys 1043 may be identified based on the values and/or cryptocurrency amounts associated with each private cryptographic key, and as such, may allow for withdrawal and/or payment of cryptocurrency to satisfy a transaction. With deposits, the private cryptographic keys may be identified by the incoming deposit request and/or provision of such keys to be deposited in one of digital wallets 1041.

In one or more embodiments, transaction processor 1030 may perform a risk analysis prior to providing access to and/or transferring keys 1043. For example, a transaction request may be detected, and upon detecting, transaction processor 1030 (e.g., using transaction processing application 1032 and/or other application having a risk analysis component or the like) may determine based on a variety of factors, a risk score associated with the user, entity, and/or transaction. The risk score may be based on factors such as prior transactions, credit/loan history, whether the user/entity has any pending loans or is late on any potential repayments, the volume of transactions the user/entity performs using the service provider, the number and/or value of transactions, fraudulent or reversed transactions, account flags, and additional related factors. Based on one or more factors, transaction processor 1030 may generate a risk score associated with the user/entity. The service provider may then compare the generated risk score with a threshold risk score to determine if the user/entity is eligible to process the transaction and/or withdraw/be paid value via transfer of keys 1043. If the risk score is at or above the threshold score, transaction processor 1030 may provide access to the keys and/or perform a transfer of the keys. If the risk score is at or below the threshold score, transaction processor 1030 may not allow the user/entity to have access to the keys and/or may decline the transaction.

At step 1308, the cryptocurrency transaction is processed with the digital wallet based on the private cryptographic key(s). Transaction processor 1030 may establish, via ephemeral wallet platform 1040 and/or transaction processing application 1032, a secure communication channel and/or other secure key transfer mechanism to exchange private cryptocurrency keys between digital wallets for the cryptocurrency transaction. The digital wallets may be identified by one or more of wallet addresses 1022 and wallet addresses 1042, and thus the digital wallet addresses on the corresponding blockchain for the cryptocurrency may be used as the sender and recipient addresses (e.g., network address or the like). The secure communication channel may be established to allow for secure exchange of the private keys. As such, for withdrawals or payments, one or more of keys 1043 may be sent via the secure communication channel. This access may include providing the user with access to cryptocurrency and/or private cryptographic keys to conduct on-chain and/or off-chain transactions with other digital wallets, thereby providing transfers of cryptocurrency via transfer to the user's digital wallet designated by one of wallet addresses 1022. For deposits, the secure communication channel may be used to receive private keys at one of wallet addresses 1042 for storage by digital wallets 1041.

At step 1310, the whitelist and/or a digital ledger associated with the private cryptographic key(s) is/are updated based on the processed transaction. Based on processing transactions 1034, a digital ledger for keys 1043 and their corresponding blockchain may be updated by ephemeral wallet platform 1040 and/or transaction processing application 1032. Updating of the digital ledger may include writing to a new or existing block to update the ledger with the transfer of keys 1043 and the cryptocurrency transaction, such as the sender and recipient digital wallet addresses. Further, whitelist 1045 may be updated to reflect that the withdrawal and/or deposit has been effectuated, thereby indicating whether future cryptocurrency transactions can and/or should be authorized with the same wallet address, user, payment code, or other identity and/or verification information.

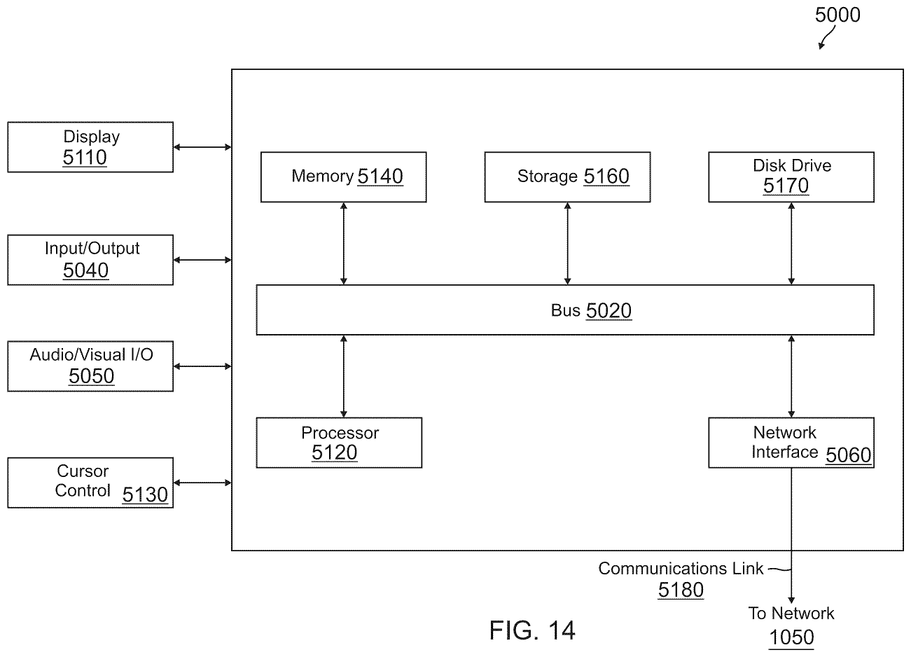

FIG. 14 is a block diagram of a computer system 5000 suitable for implementing one or more components in FIG. 10, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 5000 in a manner as follows.

Computer system 5000 includes a bus 5020 or other communication mechanism for communicating information data, signals, and information between various components of computer system 5000. Components include an input/output (I/O) component 5040 that processes a user action, such as selecting keys from a keypad/keyboard, selecting one or more buttons, image, or links, and/or moving one or more images, etc., and sends a corresponding signal to bus 5020. I/O component 5040 may also include an output component, such as a display 5110 and a cursor control 5130 (such as a keyboard, keypad, mouse, etc.). An optional audio input/output component 5050 may also be included to allow a user to use voice for inputting information by converting audio signals. Audio I/O component 5050 may allow the user to hear audio. A transceiver or network interface 5060 transmits and receives signals between computer system 5000 and other devices, such as another communication device, service device, or a service provider server via a network 1600, such as network 1050 of FIG. 10. In one embodiment, the transmission is wireless, although other transmission mediums and methods may also be suitable. One or more processors 5120, which can be a micro-controller, digital signal processor (DSP), or other processing component, processes these various signals, such as for display on computer system 5000 or transmission to other devices via a communication link 5180. Processor(s) 5120 may also control transmission of information, such as cookies or IP addresses, to other devices.

Components of computer system 5000 also include a system memory component 5140 (e.g., RAM), a static storage component 5160 (e.g., ROM), and/or a disk drive 5170. Computer system 5000 performs specific operations by processor(s) 5120 and other components by executing one or more sequences of instructions contained in system memory component 5140. Logic may be encoded in a computer readable medium, which may refer to any medium that participates in providing instructions to processor(s) 5120 for execution. Such a medium may take many forms, including but not limited to, non-volatile media, volatile media, and transmission media. In various embodiments, non-volatile media includes optical or magnetic disks, volatile media includes dynamic memory, such as system memory component 5140, and transmission media includes coaxial cables, copper wire, and fiber optics, including wires that comprise bus 5020. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 5000. In various other embodiments of the present disclosure, a plurality of computer systems 5000 coupled by communication link 5180 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method comprising:
receiving, at a digital platform, a request for a cryptocurrency transfer of a first cryptocurrency amount from a first cryptocurrency wallet managed by the digital platform, wherein the digital platform provides an ephemeral wallet service for the first cryptocurrency wallet, and wherein the ephemeral wallet service handles cryptocurrency transfers with the first cryptocurrency wallet using a whitelist for authorized cryptocurrency transfers from the first cryptocurrency wallet;
determining verification information for the request, wherein the verification information includes a destination wallet address for the cryptocurrency transfer for the first cryptocurrency amount;
authorizing, based on the verification information, the request for the cryptocurrency transfer using the whitelist for the authorized cryptocurrency transfers from the first cryptocurrency wallet;
identifying one or more first private cryptographic keys for the first cryptocurrency amount to be transferred to the destination wallet address;
establishing, between the ephemeral wallet service and the destination wallet address, a secure communication channel for transferring the one or more first private cryptographic keys to the destination wallet address;
transmitting the one or more first private cryptographic keys to the destination wallet address via the secure communication channel using the ephemeral wallet service; and
modifying a digital ledger for the ephemeral wallet service that manages the authorized cryptocurrency transfers based on the one or more first private cryptographic keys transmitted.

2. The method of claim 1, further comprising:
detecting, by the digital platform, an incoming cryptocurrency transfer designating a wallet address of the first cryptocurrency wallet as a recipient of a second cryptocurrency amount, wherein the incoming cryptocurrency transfer is associated with a sender wallet address of the second cryptocurrency amount, and wherein the incoming cryptocurrency transfer comprises one or more second private cryptographic keys received with the incoming cryptocurrency transfer; and
determining whether the sender wallet address is associated with the authorized cryptocurrency transfers based on the whitelist.

3. The method of claim 2, further comprising:
responsive to the sender wallet address being determined to not be associated with the authorized cryptocurrency transfers, returning, using the ephemeral wallet service, the one or more second private cryptographic keys to the sender wallet address.

4. The method of claim 2, further comprising:
responsive to the sender wallet address being determined to be associated with the authorized cryptocurrency transfers, accepting the one or more second private cryptographic keys at the wallet address of the first cryptocurrency wallet; and
storing the one or more second private cryptographic keys with the first cryptocurrency wallet.

5. The method of claim 1, wherein the request for the cryptocurrency transfer comprises a payment to a second cryptocurrency wallet of the first cryptocurrency amount that is time limited by the ephemeral wallet service for available cryptocurrency held by the first cryptocurrency wallet, and wherein the identifying the one or more first private cryptographic keys comprises:
determining values for different private cryptographic keys associated with the available cryptocurrency held by the first cryptocurrency wallet; and
selecting the one or more first private cryptographic keys for a total of the payment based on the values for the different private cryptographic keys.

6. The method of claim 1, wherein the authorizing the request comprises:
determining whether the whitelist includes at least one of a payment code authorizing the cryptocurrency transfer, a user identity associated with the request, or the destination wallet address.

7. The method of claim 1, wherein, prior to the receiving the request, the method further comprises:
establishing the whitelist and a governor function of the ephemeral wallet service for a wallet address of the first cryptocurrency wallet, wherein the governor function limits incoming and outgoing cryptocurrency transfers using the wallet address, and wherein the ephemeral wallet service monitors the wallet address on a blockchain using the governor function for the incoming and outgoing cryptocurrency transfers.

8. The method of claim 7, wherein the establishing the whitelist includes generating a plurality of payment codes usable to authorize payments to be made from the first cryptocurrency wallet.

9. A system comprising:
a non-transitory memory; and
one or more hardware processors coupled to the non-transitory memory and configured to execute instructions to cause the system to:
receive a request to establish a cryptocurrency wallet for an amount of cryptocurrency with an ephemeral wallet service that provides the cryptocurrency wallet and a digital wallet address for the cryptocurrency wallet for cryptocurrency transfers for a limited time period, wherein the request designates a set of allowable cryptocurrency transfers to and from the digital wallet address using the cryptocurrency wallet;
create a whitelist of the set of allowable cryptocurrency transfers and a digital ledger for the amount of cryptocurrency to be held by the cryptocurrency wallet;
create the cryptocurrency wallet with the ephemeral wallet service;
establish the digital wallet address on a blockchain associated with the amount of cryptocurrency;
transfer the amount of cryptocurrency from at least one other cryptocurrency wallet to the cryptocurrency wallet; and
create a function for the cryptocurrency wallet using the ephemeral wallet service, wherein the function comprises one or more executable processes that manage the set of allowable cryptocurrency transfers to and from the digital wallet address on the blockchain for the cryptocurrency wallet based on the whitelist.

10. The system of claim 9, wherein the whitelist is created based on a set of data records associated with the set of allowable cryptocurrency transfers, and wherein each of the set of data records designates a payment amount of a portion of the amount of cryptocurrency for specified verification information.

11. The system of claim 10, wherein the specified verification information comprises one of a user identification, another digital wallet address, or a payment code.

12. The system of claim 9, wherein the whitelist comprises a depositor digital wallet address that limits deposits to the cryptocurrency wallet from only the depositor digital wallet address.

13. The system of claim 9, wherein the instructions are further executable to cause the system to:
receive a request for a portion of the amount of cryptocurrency;
verify the request based on verification information associated with the request; and
process a cryptocurrency transaction between the digital wallet address of the cryptocurrency wallet and another digital wallet address of another digital wallet specified by the request.

14. The system of claim 13, wherein, prior to the processing the cryptocurrency transaction, the instructions are further executable to cause the system to:
establish a secure communication channel between the digital wallet address and the other digital wallet address for the cryptocurrency transaction,
wherein processing the cryptocurrency transaction is performed via the secure communication channel.

15. The system of claim 14, wherein the secure communication channel enables a transfer of one or more private cryptographic keys corresponding to the portion of the amount of cryptocurrency between the digital wallet address and the other digital wallet address.

16. The system of claim 9, wherein the one or more executable processes are configured to access the whitelist via one of an application programming interface (API) or a smart contract associated with the whitelist.

17. A non-transitory machine-readable medium having stored thereon machine-readable instructions executable to cause a machine to perform operations comprising:
receiving a cryptocurrency transaction at a digital platform for a first wallet address corresponding to a first digital wallet managed by the digital platform, wherein the digital platform utilizes a whitelist to authorize cryptocurrency transactions that include the first wallet address as a sender or a receiver of cryptocurrency, and wherein the cryptocurrency transaction designates a second wallet address for a second digital wallet;
authorizing the cryptocurrency transaction based on the whitelist and verification information associated with the cryptocurrency transaction;
transferring a private key for an amount of a cryptocurrency corresponding to the cryptocurrency transaction between the first digital wallet and the second digital wallet using a secure communication channel, the first wallet address, and the second wallet address; and
updating the whitelist and a digital ledger corresponding to the key based on the cryptocurrency transaction.

18. The non-transitory machine-readable medium of claim 17, wherein the cryptocurrency transaction comprises one of a withdrawal of the private key or a deposit of the private key, wherein the withdrawal is limited to an amount identified in the whitelist, and wherein the deposit is limited to one or more authorized wallet address in the whitelist.

19. The non-transitory machine-readable medium of claim 17, wherein the whitelist corresponds to a settlement class provided from an upload of a list of users by an entity.

20. The non-transitory machine-readable medium of claim 17, wherein the whitelist comprises one of an application programming interface (API) that is callable for the authorizing or a smart contract on the blockchain that is readable for the authorization, and wherein the whitelist limits withdrawals and deposits to the first cryptocurrency wallet for a length of time.
